(19) United States
(12) Patent Application Publication
(10) Pub. No.: US 2023/0046510 A1
(43) Pub. Date: Feb. 16, 2023

(54) MAGNETIC DISK DEVICE AND REFRESH PROCESSING METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Seishiro FUJIWARA, Yokohama Kanagawa (JP)

(21) Appl. No.: 17/678,333

(22) Filed: Feb. 23, 2022

(30) Foreign Application Priority Data
Aug. 10, 2021 (JP) 2021-130853

(51) Int. Cl. G11B 21/10; G11B 5/012

(52) U.S. Cl. CPC G11B 21/106; G11B 5/012

(57) ABSTRACT

According to one embodiment, a magnetic disk device including a disk including a user data region having a first region to which data is written by shingled recording and a cache region to which data is written by normal recording and is temporarily written before writing the data in the user data region, a head, and a controller including a first saving threshold value of the number of times of writing that data is written in the radial direction of the first region for saving a track located at an end portion of the first region in the radial direction into the cache region, and a refresh threshold value of the number of times of the writing for rewriting a plurality of tracks shingled recorded in the first region.

### CROSS-REFERENCE TO RELATED APPLICATIONS

This application is based upon and claims the benefit of priority from Japanese Patent Application No. 2021-130853, filed Aug. 10, 2021, the entire contents of which are incorporated herein by reference.

### FIELD

Embodiments described herein relate generally to a magnetic disk device and a refresh processing method.

### BACKGROUND

In a magnetic disk device, side erasing in which data is erased may occur due to an influence (Adjacent Track Interference: ATI) of a leakage magnetic flux or the like from a head when data is written. In order to prevent side erasing, the magnetic disk device has a process of rewriting data of a particular track (refresh process or rewrite process) when the number of times of writing data to peripheral tracks of the particular track exceeds a specified number of times.

Magnetic disk devices having a technique that achieves high recording density have been developed. An example of a magnetic disk device that achieves high recording density includes a magnetic disk device that can execute a shingled write magnetic recording (SMR) or a shingled write recording (SWR) in which a plurality of tracks is overwritten in the radial direction of the disk.

The shingled write magnetic recording type magnetic disk device shingled records data for each region (hereinafter, may be referred to as a band region) including a particular number of tracks. The shingled write magnetic recording type magnetic disk device performs the refresh process of rewriting data written in a particular band region to the same region when the number of times of writing data to a band region around the particular band region exceeds a specified number of times. In the shingled write magnetic recording type magnetic disk device, since the data at the end portion of the band region in the radial direction receives the ATI most, the refresh process can be executed so that the data at the end portion of the band region in the radial direction is not side-erased.

### BRIEF DESCRIPTION OF THE DRAWINGS

FIG. 1 is a block diagram showing a configuration of a magnetic disk device according to a first embodiment.

FIG. 2 is a schematic view showing an example of a disk according to the first embodiment.

FIG. 3 is a schematic diagram showing an example of a shingled write magnetic recording process.

FIG. 4 is a schematic diagram showing an example of a conventional magnetic recording process.

FIG. 5 is a schematic diagram illustrating an example of a process of writing data in a disk.

FIG. 6 is a schematic diagram illustrating an example of a sector error rate characteristic of each track in a band region.

FIG. 7 is a schematic diagram illustrating an example of a table of the number times of writing, a saving threshold value, and a refresh threshold value according to the first embodiment.

FIG. 8 is a schematic diagram illustrating an example of a saving processing method and a refresh processing method according to the first embodiment.

FIG. 9 is a schematic diagram illustrating an example of a saving processing method and a refresh processing method according to the first embodiment.

FIG. 10 is a flowchart showing an example of a refresh processing method according to the first embodiment.

FIG. 11 is a flowchart showing an example of a refresh processing method according to Modification 1.

FIG. 12 is a schematic diagram illustrating an example of a table of the number of times of writing, a saving threshold value, and a refresh threshold value according to Modification 2.

FIG. 13 is a schematic diagram illustrating an example of a table of the number of times of writing, a saving threshold value, and a refresh threshold value according to Modification 3.

FIG. 14 is a flowchart showing an example of a refresh processing method according to Modification 3.

FIG. 15 is a schematic diagram illustrating an example of a table of the number of times of writing, a saving threshold value, and a refresh threshold value according to the second embodiment.

FIG. 16 is a schematic diagram illustrating an example of a saving processing method and a refresh processing method according to the second embodiment.

FIG. 17 is a schematic diagram illustrating an example of a saving processing method and a refresh processing method according to the second embodiment.

FIG. 18 is a flowchart showing an example of a refresh processing method according to the second embodiment.

### DETAILED DESCRIPTION

In general, according to one embodiment, a magnetic disk device comprising: a disk including a user data region having a first region to which data is written by shingled recording in which a plurality of tracks is written in an overlapping manner in a first direction of a radial direction and a cache region to which data is written by normal recording in which a plurality of tracks is written at intervals in a radial direction and is temporarily written before writing the data in the user data region; a head that writes data to the disk and reads data from the disk; and a controller including a first saving threshold value of the number of times of writing that data is written in the radial direction of the first region for saving a track located at an end portion of the first region in the radial direction into the cache region, and a refresh threshold value of the number of times of the writing for rewriting a plurality of tracks shingled recorded in the first region.

Hereinafter, embodiments will be described with reference to the drawings. It should be noted that the drawings are merely examples and do not limit the scope of the invention.

### First Embodiment

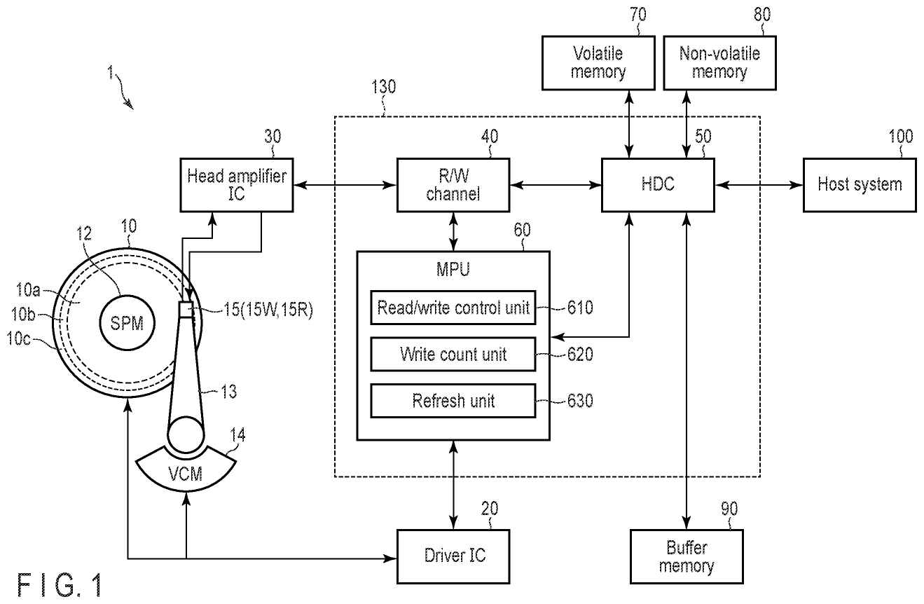

FIG. 1 is a block diagram showing an example of a configuration of a magnetic disk device 1 according to a first embodiment.

The magnetic disk device 1 includes a head disk assembly (HDA), a driver IC 20, a head amplifier integrated circuit (hereinafter referred to as a head amplifier IC or a preamplifier) 30, a volatile memory 70, a non-volatile memory 80, a buffer memory (buffer) 90, and a system controller 130 which is an integrated circuit of one chip. Further, the magnetic disk device 1 is connected to a host system (hereinafter simply referred to as a host) 100.

The HDA includes a magnetic disk (hereinafter referred to as a disk) 10, a spindle motor (hereinafter referred to as an SPM) 12, an arm 13 on which a head 15 is mounted, a voice coil motor (hereinafter referred to as a VCM) 14. The disk 10 is attached to the SPM 12 and is rotated by the drive of the SPM 12. The arm 13 and the VCM 14 constitute an actuator. The actuator controls the movement of the head 15 mounted on the arm 13 to a particular position of the disk 10 by driving the VCM 14. The two or more disks 10 and the two or more heads 15 may be provided.

In the disk 10, a user data region 10a that can be used by the user, a media cache (or sometimes referred to as a media cache region or cache region) 10b that temporarily holds (writes) data (or commands) transferred from a host or the like before performing writing to a particular region of the user data region 10a, and a system area 10c in which the information required for system management is written are allocated in a region where the data can be written. Hereinafter, the direction from the inner circumference to the outer circumference of the disk 10 or the direction from the outer circumference to the inner circumference of the disk 10 is referred to as a radial direction. In the radial direction, the direction from the inner circumference to the outer circumference is referred to as the outward direction (outside), and the direction from the outer circumference to the inner circumference is referred to as the inward direction (inside). A direction orthogonal to the radial direction of the disk 10 is referred to as a circumferential direction. The circumferential direction corresponds to the direction along the circumference of the disk 10. Further, a particular position of the disk 10 in the radial direction may be referred to as a radial position, and a particular position of the disk 10 in the circumferential direction may be referred to as a circumferential position. The radial position and the circumferential position may be collectively referred to as a position. The “track” is used in various meanings including one recording area among a plurality of recording areas obtained by dividing the disk 10 in the radial direction, a recording area for one turn at a particular radial position of the disk 10, a particular recording region at a particular radial position of the disk 10, a recording area extending in a circumferential direction of the disk 10, a recording area corresponding to a path of the head 15 positioned at a particular radial position of the disk 10, a path of the head 15 positioned at a particular radial position of the disk 10, data written to one recording area among a plurality of recording areas obtained by dividing the disk 10 in the radial direction, data written to a recording area for one turn at a particular radial position of the disk 10, data written to a particular recording region at a particular radial position of the disk 10, data written to a recording area extending in the circumferential direction of the disk 10, data written to a recording area corresponding to a path of the head 15 positioned at a particular radial position of the disk 10, data written along the path of the head 15 positioned at a particular radial position of the disk 10, data extending in the circumferential direction of the disk 10, data written to a particular track of the disk 10, data for one turn written to a particular track of the disk 10, part of data written to a particular track of the disk 10, and others. The “sector” is used in various meanings including one recording area among a plurality of recording areas obtained by dividing a particular track of the disk 10 in the circumferential direction, one recording area among a plurality of recording areas obtained by dividing a recording area extending in a circumferential direction at a particular radial position of the disk 10, a particular recording region of a particular track of the disk 10, a particular circumferential position of a particular track of the disk 10, a particular circumferential position (particular position) at a particular radial position of the disk 10, data written to one recording area among a plurality of recording areas obtained by dividing a particular track of the disk 10 in the circumferential direction, data written in one recording area of a plurality of recording areas obtained by dividing the recording area extending in the circumferential direction at a particular radial position of the disk 10, data written in a particular recording region of a particular track of the disk 10, data written at a particular circumferential position of a particular track of the disk 10, data written at a particular circumferential position (particular position) at a particular radial position of the disk 10, data written to a particular sector, and others. The “radial width of the track” may be referred to as a “track width”. “A path that passes through the center position of the track width in a particular track” is referred to as a “track center”. The data available by the user written to the user data region 10a may be referred to as user data.

The head 15 has a slider as a main body, and has a write head 15W and a read head 15R mounted on the slider. The write head 15W writes data to the disk 10. The read head 15R reads the data written to the disk 10. In addition, the “write head 15W” may be simply referred to as the “head 15”, the “read head 15R” may be simply referred to as the “head 15”, and the “write head 15W and read head 15R” may be collectively referred to as the “head 15”. The “center of the head 15” may be referred to as the “head 15”, the “center of the write head 15W” may be referred to as the “write head 15W”, and the “center of the read head 15R” may be referred to as the “read head 15R”. The “center of the write head 15W” may be simply referred to as the “head 15”, and the “center of the read head 15R” may be simply referred to as the “head 15”. “Positioning the center of the head 15 to the track center of a particular track” may be expressed as “positioning the head 15 to a particular track”, “disposing the head 15 on a particular track”, or “locating the head 15 on a particular track”.

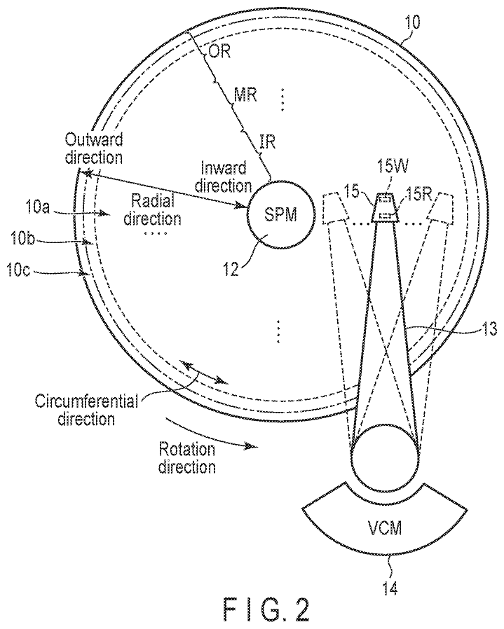

FIG. 2 is a schematic view showing an example of the disk 10 according to the present embodiment. As shown in FIG. 2, the direction in which the disk 10 rotates in the circumferential direction is referred to as a rotation direction. In the example shown in FIG. 2, the rotation direction is shown counterclockwise, but it may be in the opposite direction (clockwise). In FIG. 2, the disk 10 is divided into an inner circumference region IR located inward, an outer circumference region OR located outward, and a middle circumference region MR located between the inner circumference region IR and the outer circumference region OR.

In the example shown in FIG. 2, the disk 10 includes the user data region 10a, the media cache 10b, and the system area 10c. In FIG. 2, the user data region 10a, the media cache 10b, and the system area 10c are disposed in the order described in the outward direction. In FIG. 2, the media cache 10b is disposed adjacent to the user data region 10a in the outward direction. In other words, the media cache 10b is located between the user data region 10a and the system area 10c. Here, “adjacent” includes not only a state in which data, an object, a region, a space, and the like are disposed in contact with each other, but also a state in which they are disposed at a particular interval. In FIG. 2, the system area 10c is disposed adjacent to the media cache 10b in the outward direction. The arrangement order of the user data region 10a, the media cache 10b, and the system area 10c is not limited to the order shown in FIG. 2, but may be any order. Further, when the media cache 10b is not disposed on the disk 10, the system area 10c may be disposed adjacent to the user data region 10a in the outward direction.

In the example shown in FIG. 2, the user data region 10a is disposed from the inner circumference region IR to the outer circumference region OR in the radial direction. In the example shown in FIG. 2, the media cache 10b is disposed in the outer circumference region OR in the radial direction. The media cache 10b may be located in the inner circumference region IR or the middle circumference region MR. Further, the media cache 10b may be dispersedly located in the outer circumference region OR, the middle circumference region MR, and the inner circumference region IR. In the example shown in FIG. 2, the system area 10c is disposed in the outer circumference region OR in the radial direction. In other words, the system area 10c is disposed from a particular position of the outer circumference region OR to the outermost circumference of the disk 10. Note that the system area 10c may be disposed in the middle circumference region MR or the inner circumference region IR.

Data can be written to the user data region 10a of disk 10 in a shingled write magnetic recording (SMR), or shingled write recording (SWR) type in which the track to be written next (hereinafter, may be referred to as a next track) is overwritten on part of a particular track in the radial direction. Data can be written to the user data region 10a in the conventional magnetic recording (CMR) type in which a track (hereinafter, may be referred to as an adjacent track) that is radially adjacent to a particular track is written away from this particular track by a particular interval (a gap) in the radial direction or data can be randomly written. Hereinafter, “write data in the shingled write magnetic recording type” may be simply referred to as “shingled record”, “perform a shingled write magnetic recording process”, or simply “write”. The write process other than the “conventional magnetic recording process” may be referred to as a “shingled write magnetic recording process”. In addition, “write data in conventional magnetic recording type” may be simply referred to as “conventionally record”, “perform a conventional magnetic recording process”, or simply as “write”.

As shown in FIG. 2, the head 15 is driven by the VCM 14 with respect to the disk 10 to rotate around the rotation axis, moves from the inward direction to the outward direction to be disposed at a particular position, or moves from the outward direction to the inward direction to be disposed at a particular position.

The driver IC 20 controls the driving of the SPM 12 and the VCM 14 according to the control of the system controller 130 (specifically, the MPU 60 described later).

The head amplifier IC (preamplifier) 30 includes a read amplifier, a write driver, and the like. The read amplifier amplifies the read signal read from the disk 10 to output it to the system controller 130 (specifically, a read/write (R/W) channel 40 to be described later). The write driver outputs a write current corresponding to the signal output from the R/W channel 40 to the head 15.

The volatile memory 70 is a semiconductor memory from which stored data is lost when power supply is cut off. The volatile memory 70 stores data and the like necessary for processing in each part of the magnetic disk device 1. The volatile memory 70 is, for example, a dynamic random access memory (DRAM) or a synchronous dynamic random access memory (SDRAM).

The non-volatile memory 80 is a semiconductor memory that records data stored even when power supply is cut off. The non-volatile memory 80 is, for example, a NOR type or NAND type flash read only memory (FROM).

The buffer memory 90 is a semiconductor memory that temporarily records data and the like transmitted and received between the magnetic disk device 1 and a host 100. It is to be noted that the buffer memory 90 may be formed integrally with the volatile memory 70. The buffer memory 90 is, for example, a DRAM, a static random access memory (SRAM), an SDRAM, a ferroelectric random access memory (FeRAM), a magnetoresistive random access memory (MRAM), or the like.

The system controller (controller) 130 is implemented by using a large scale integrated circuit (LSI) referred to as the System-on-a-Chip (SoC) in which a plurality of elements is integrated on a single chip, for example. The system controller 130 includes a read/write (R/W) channel 40, hard disk controller (HDC) 50, and a microprocessor (MPU) 60. The system controller 130 is electrically connected to, for example, the driver IC 20, the head amplifier IC 30, the volatile memory 70, the non-volatile memory 80, the buffer memory 90, the host system 100, and the like.

The R/W channel 40 responds to an instruction from the MPU 60 to be described later, performs the signal process of the data (hereinafter, may be referred to as read data) transferred from the disk 10 to the host 100 and the data (hereinafter, may be referred to as write data) transferred from the host 100. The R/W channel 40 has a circuit or a function of modulating write data. The R/W channel 40 has a circuit or a function for measuring and demodulating a signal quality of read data. The R/W channel 40 is electrically connected to the head amplifier IC 30, the HDC 50, the MPU 60, and the like, for example.

The HDC 50 controls data transfer. For example, the HDC 50 controls data transfer between the host 100 and the disk 10 in response to an instruction from the MPU 60 described later. The HDC 50 is electrically connected to, for example, the R/W channel 40, the MPU 60, the volatile memory 70, the non-volatile memory 80, the buffer memory 90, and the like.

The MPU 60 is a main controller that controls respective units of the magnetic disk device 1. The MPU 60 controls the VCM 14 via the driver IC 20 and executes servo control that positions the head 15. The MPU 60 also controls the SPM 12 via the driver IC 20 to rotate the disk 10. The MPU 60 controls a write operation of the data to the disk 10 and selects the storage destination of the data, for example, write data, transferred from the host 100. The MPU 60 controls the read operation of the data from the disk 10 and controls the process of the data transferred from the disk 10 to the host 100, for example, read data. The MPU 60 also manages a region for recording data. The MPU 60 is connected to each part of the magnetic disk device 1. The MPU 60 is electrically connected to the driver IC 20, the R/W channel 40, the HDC 50, and the like, for example.

The MPU 60 includes a read/write control unit 610, a write count unit 620, a refresh unit 630, and the like. The MPU 60 executes the process of each unit, for example, the read/write control unit 610, the write count unit 620, the refresh unit 630, and the like on the firmware. The MPU 60 may include respective units, for example, the read/write control unit 610, the write count unit 620, the refresh unit 630, and the like as a circuit. The read/write control unit 610, the write count unit 620, the refresh unit 630, and the like may be included in the R/W channel 40 or the HDC 50.

The read/write control unit 610 controls a read process of reading data from the disk 10 and a write process of writing data to the disk 10 according to a command or the like from the host 100. The read/write control unit 610 controls the VCM 14 via the driver IC 20, positions the head 15 at a particular position of the disk 10, and performs the read process or the write process. Hereinafter, the term “access” may be used in a meaning including recording or writing data to a particular region (or write process), reading out or reading data from a particular region (or read process), or moving the head 15 or the like to a particular region.

The read/write control unit 610 overwrites (or shingled records), with the next track, part of the track in the radial direction for a particular region (hereinafter, may be referred to as a band or a band region) of the disk 10 according to a command or the like from the host 100. “Overwrite data” includes “overwrite part of one data of at least two data with another data” and “overwrite one data of at least two data with another data being shifted”. The read/write control unit 610 sequentially shingled records a plurality of tracks (or track group) for each band region. The read/write control unit 610 arranges the plurality of band regions at particular intervals (gaps) in the radial direction. In the band region, a track located at one end portion in the radial direction and to be written first may be referred to as an initial track, and a track located at the other end portion opposite to the one end portion in the radial direction and to be written last may be referred to as a last track. In a particular band region, the track written immediately before (hereinafter, may be referred to as a previous track) is not overwritten with the initial track, and the initial track is overwritten with the next track. The initial track is located at the end portion of the particular band region in the reverse forward direction. In a particular band region, the previous track is overwritten with the last track and the last track is not overwritten with the next track. The last track is located at the end portion of the particular band region in the forward direction. In the particular band region, the track width of the last track is larger than the track widths of the other tracks.

The read/write control unit 610 writes an adjacent track of a particular track at a particular interval (gap) in the radial direction in a particular region of the disk 10 or writes data randomly (or conventionally records) according to a command or the like from the host 100.

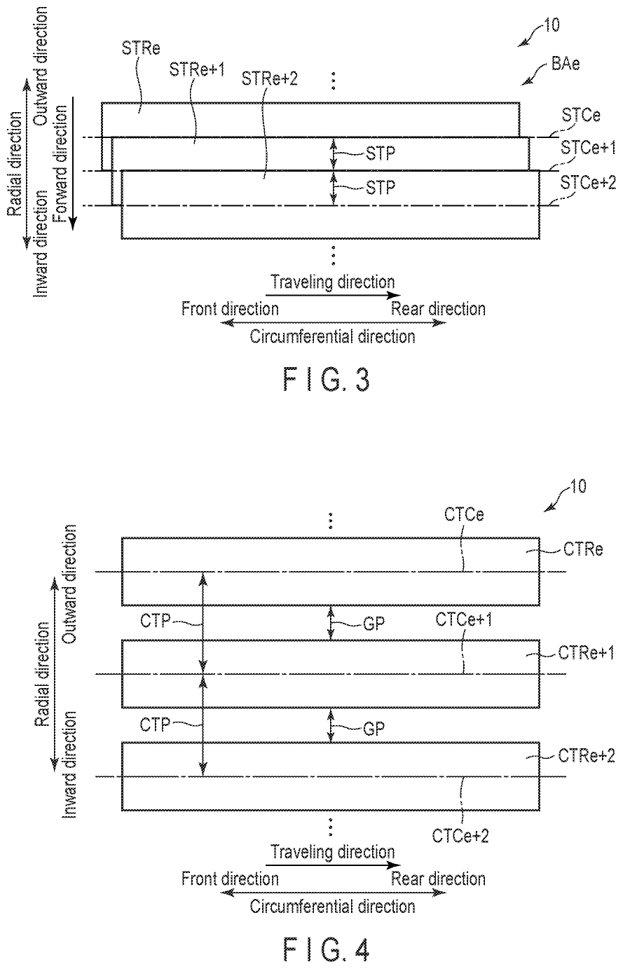

FIG. 3 is a schematic view showing an example of the shingled write magnetic recording process. FIG. 3 illustrates a traveling direction in the circumferential direction. A direction in which the head 15 sequentially writes and reads data with respect to the disk 10 in the circumferential direction, that is, a direction in which the head 15 travels with respect to the disk 10 in the circumferential direction may be referred to as a traveling direction. For example, the traveling direction is opposite to the rotation direction of the disk 10. The traveling direction may be the same as the rotation direction of the disk 10. Terms such as “same”, “identical”, “match”, and “equivalent” include the meaning of being exactly the same, as well as the meaning of being different to the extent that they can be considered to be substantially the same. In the circumferential direction, the traveling direction may be referred to as a rear direction or simply as rear. In the circumferential direction, a direction opposite to the rear direction may be referred to as a front direction or simply as front. FIG. 3 illustrates a forward direction in the radial direction. A direction in which a plurality of tracks is continuously shingled recorded in the radial direction, that is, a direction in which a track to be written next is overlapped on a track written immediately before in the radial direction may be referred to as a forward direction. In FIG. 3, the inward direction is the forward direction in the radial direction, but the outward direction may be the forward direction. Hereinafter, the direction opposite to the forward direction may be referred to as a reverse forward direction.

FIG. 3 illustrates a band region BAe. In the band region BAe of FIG. 3, a plurality of tracks STRe, STRe+1, and STRe+2 is continuously overwritten in the forward direction in the described order. In FIG. 3, the track STRe corresponds to the initial track, and the track STRe+2 corresponds to the last track. Hereinafter, in the shingled recording, a region to which data is written by the write head 15W may be referred to as a write track, and a remaining region other than a region, of a particular track, that is overwritten with another write track may be referred to as a read track. FIG. 3 illustrates a track center STCe of the track STRe when not overwritten with another track, a track center STCe+1 of the track STRe+1 when not overwritten with another track, and a track center STCe+2 of the track STRe+2 when not overwritten with another track. In the example illustrated in FIG. 3, the tracks STRe, STRe+1, and STRe+2 are written at the track pitch STP. The track center STCe of the track STRe and the track center STCe+1 of the track STRe+1 are away by the track pitch STP. The track center STCe+1 of the track STRe+1 and the track center STCe+2 of the track STRe+2 are away by the track pitch STP. The tracks STRe to STRe+2 may be written at different track pitches. In FIG. 3, the radial width of the region of the track STRe that is not overwritten with the track STRe+1 is the same as the radial width of the region of the track STRe+1 that is not overwritten with the track STRe+2. Note that the radial width of the region of the track STRe that is not overwritten with the track STRe+1 may be different from the radial width of the region of the track STRe+1 that is not overwritten with the track STRe+2. In FIG. 3, for convenience of explanation, each track is shown as a rectangle extending in the circumferential direction with a particular track width, but practically, it is curved along the circumferential direction. Further, each track may have a wavy shape extending in the circumferential direction while fluctuating in the radial direction. In FIG. 3, three tracks are overwritten, but less than three tracks or more than three tracks may be overwritten.

In the example illustrated in FIG. 3, the read/write control unit 610 sequentially shingled records the tracks STRe to STRe+2 at the track pitch STP in the band region BAe inward. Note that the read/write control unit 610 may sequentially shingled records the tracks STRe to STRe+2 at the track pitch STP in the outward direction. The read/write control unit 610 writes the track STRe+1 at the track pitch STP in the inward direction of the track STRe, and overwrites part of the track STRe in the inward direction with the track STRe+1. The read/write control unit 610 writes the track STRe+2 at the track pitch STP in the inward direction of the track STRe+1 and overwrites part of the track STRe+1 in the inward direction with the track STRe+2.

FIG. 4 is a schematic diagram showing an example of the conventional magnetic recording process. FIG. 4 illustrates tracks CTRe, CTRe+1, and CTRe+2. In FIG. 4, for example, the track widths of the tracks CTRe, CTRe+1, and CTRe+2 are the same. Note that the track widths of the tracks CTRe to CTRe+2 may be different. FIG. 4 illustrates a track center CTCe of the track CTRe, a track center CTCe+1 of the track CTRe+1, and a track center CTCe+2 of the track CTRe+2. In the example illustrated in FIG. 4, the tracks CTRe, CTRe+1, and CTRe+2 are written at the track pitch CTP. The track center CTCe of the track CTRe and the track center CTCe+1 of the track CTRe+1 are away by the track pitch CTP. The track center CTCe+1 of the track CTRe+1 and the track center CTCe+2 of the track CTRe+2 are away by the track pitch CTP. The track CTRe and the track CTRe+1 are away by the gap GP. The track CTRe+1 and the track CTRe+2 are away by the gap GP. Note that the tracks CTRe to CTRe+2 may be written at different track pitches. In FIG. 4, for convenience of explanation, each track is shown in a rectangular shape extending in the circumferential direction with a particular track width, but practically, it is curved along the circumferential direction. Further, each track may have a wavy shape extending in the circumferential direction while fluctuating in the radial direction.

In the example illustrated in FIG. 4, the read/write control unit 610 positions the head 15 at the track center CTCe in a particular region of the disk 10 and conventionally records the track CTRe or a particular sector of the track CTRe. The MPU 60 positions the head 15 at the track center CTCe+1 spaced away from the track center CTCe of the track CTRe in the inward direction by the track pitch CTP, and conventionally records the track CTRe+1 or a particular sector of the track CTRe+1. The read/write control unit 610 positions the head 15 at the track center CTCe+2 spaced away from the track center CTCe+1 of the track CTRe+1 in the inward direction by the track pitch CTP, and conventionally records the track CTRe+2 or a particular sector of the track CTRe+2. The read/write control unit 610 may conventionally record the tracks CTRe, CTRe+1, and CTRe+2 sequentially, or may conventionally record a particular sector of the track CTRe, a particular sector of CTRe+1, and a particular sector of CTRe+2 randomly in a particular region of the disk 10.

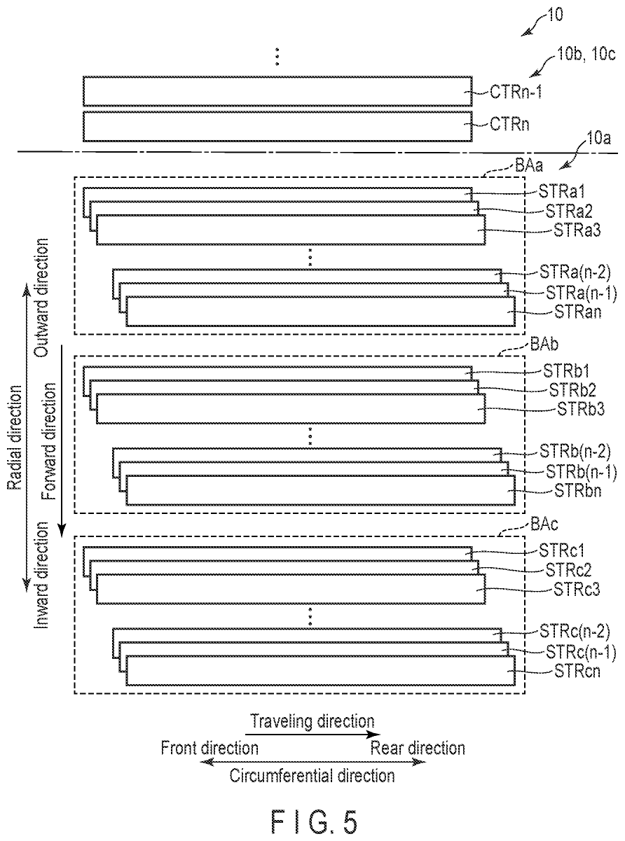

FIG. 5 is a schematic diagram illustrating an example of a process of writing data in the disk 10. FIG. 5 illustrates band regions BAa, BAb, and BAc. In FIG. 5, the band regions BAa, BAb, and BAc are continuously disposed in the forward direction in the described order in the user data region 10a. The band regions BAa and BAb are adjacent in the radial direction. The band region BAa is adjacent to the band region BAb in the reverse forward direction. The band regions BAb and BAc are adjacent in the radial direction. The band region BAc is adjacent to the band region BAb in the forward direction. The band region BAa includes tracks STRa1, STRa2, STRa3, . . . , STRa(n−2), STRa(n−1), and STRan. The tracks STRa1 to STRan are shingled recorded in the forward direction in the described order. In the band region BAa, the track STRa1 corresponds to the initial track, and the track STRan corresponds to the last track. The band region BAb includes tracks STRb1, STRb2, STRb3, . . . , STRb(n−2), STRb(n−1), and STRbn. The tracks STRb1 to STRbn are shingled recorded in the forward direction in the described order. In the band region BAb, the track STRb1 corresponds to the initial track, and the track STRbn corresponds to the last track. The band region BAc includes tracks STRc1, STRc2, STRc3, . . . , STRc(n−2), STRc(n−1), and STRcn. The tracks STRc1 to STRcn are shingled recorded in the forward direction in the described order. In the band region BAc, the track STRc1 corresponds to the initial track, and the track STRcn corresponds to the last track. FIG. 5 illustrates tracks CTRn−1 and CTRn. In FIG. 5, the tracks CTRn−1 and CTRn are conventionally recorded continuously in the forward direction in the order described in the media cache 10b or the system area 10c. In the example illustrated in FIG. 5, the tracks CTRn−1 and CTRn are adjacent to each other in the radial direction. The track CTRn is conventionally recorded at an interval in the forward direction of the track CTRn−1.

The read/write control unit 610 shingled records the tracks STRa1 to STRan in the band region BAa of the user data region 10a. The read/write control unit 610 shingled records the tracks STRb1 to STRbn in the band region BAb of the user data region 10a. The read/write control unit 610 shingled records the tracks STRc1 to STRcn in the band region BAc of the user data region 10a.

The read/write control unit 610 conventionally records the track CTRn−1 in the media cache 10b or the system area 10c. The read/write control unit 610 conventionally records the track CTRn in the forward direction of the track CTRn−1 in the media cache 10b or the system area 10c.

The write count unit 620 counts the number of times the data is written (hereinafter, may be referred to as the number of times of writing). The write count unit 620 counts the number of times of writing (hereinafter, may be referred to as the number of times of proximity region writing) that data is written to a region (hereinafter, may be referred to as a proximity region) located within a particular range from a region of target (hereinafter, may be referred to as a target region) in the radial direction. For example, the write count unit 620 counts the number of times of proximity region writing (hereinafter, may be referred to as the number of times of forward direction proximity region writing or the number of times of forward direction writing) that data is written to the proximity region (hereinafter, may be referred to as a forward direction proximity region) located within a particular range from the target region in the forward direction. In addition, for example, the write count unit 620 counts the number of times of proximity region writing (hereinafter, may be referred to as the number of times of reverse forward direction proximity region writing or the number of times of reverse forward direction writing) that data is written in the proximity region (hereinafter, may be referred to as a reverse forward direction proximity region) located within a particular range from the target region in the reverse forward direction. The write count unit 620 may hold the number of times of writing as a table in a particular recording region, for example, the system area 10c, the volatile memory 70, the non-volatile memory 80, the buffer memory 90, or the like of the disk 10.

When data is written to a proximity region located within a particular range from the target region in the radial direction, the write count unit 620 increases (increments) the number of times of proximity region writing by a particular value. For example, the write count unit 620 increases (increments) the number of times of proximity region writing by one when the data is written to the proximity region located within a particular range from the target region in the radial direction. When data is written to the forward direction proximity region, the write count unit 620 increases (increments) the number of times of forward direction proximity region writing (the number of times of forward direction writing) by a particular value. For example, the write count unit 620 increases (increments) the number of times of forward direction proximity region writing (the number of times of forward direction writing) by one when data is written to the forward direction proximity region. When data is written to the reverse forward direction proximity region, the write count unit 620 increases (increments) the number of times of reverse forward direction proximity region writing (the number of times of reverse forward direction writing) by a particular value. For example, the write count unit 620 increases (increments) the number of times of reverse forward direction proximity region writing (the number of times of reverse forward direction writing) by one when data is written to the reverse forward direction proximity region.

The write count unit 620 counts the number of times of writing (hereinafter, may be referred to as the number of times of adjacent region writing) that data is written to the region (hereinafter, may be referred to as an adjacent region) that is adjacent to the target region in the radial direction. For example, the write count unit 620 counts the number of times of adjacent region writing (hereinafter, may be referred to as the number of times of forward direction adjacent region writing or the number of times of forward direction writing) that data is written to the adjacent region (hereinafter, may be referred to as a forward direction adjacent region) adjacent to the target region in the forward direction. In addition, for example, the write count unit 620 counts the number of times of adjacent region writing (hereinafter, may be referred to as the number of times of reverse forward direction adjacent region writing or the number of times of reverse forward direction writing) that data is written to the adjacent region (hereinafter, may be referred to as a reverse forward direction adjacent region) adjacent to the target region in the reverse forward direction.

When data is written to an adjacent region located in the radial direction of the target region, the write count unit 620 increases (increments) the number of times of adjacent region writing by a particular value. For example, when data is written to an adjacent region located in the radial direction of the target region, the write count unit 620 increases (increments) the number of times of adjacent region writing by one. When data is written to the forward direction adjacent region, the write count unit 620 increases (increments) the number of times of forward direction adjacent region writing (the number of times of forward direction writing) by a particular value. For example, the write count unit 620 increases (increments) the number of times of forward direction adjacent region writing (the number of times of forward direction writing) by one when data is written to the forward direction adjacent region. When data is written to the reverse forward direction adjacent region, the write count unit 620 increases (increments) the number of times of reverse forward direction adjacent region writing (the number of times of reverse forward direction writing) by a particular value. For example, the write count unit 620 increases (increments) the number of times of reverse forward direction adjacent region writing (the number of times of reverse forward direction writing) by one when data is written to the reverse forward direction adjacent region.

The write count unit 620 counts the number of times of writing (hereinafter, may be referred to as the number of times of adjacent band writing) that data is written to a band region (hereinafter, may be referred to as an adjacent band region) adjacent to the band region of target (hereinafter, may be referred to as a target band region) in the radial direction. For example, the write count unit 620 counts the number of times of adjacent band writing (hereinafter, may be referred to as the number of times of forward direction adjacent band writing or the number of times of forward direction writing) that data is written to the adjacent band region (hereinafter, may be referred to as a forward direction adjacent band region or a forward direction band region) adjacent to the target band region in the forward direction. In addition, for example, the write count unit 620 counts the number of times of adjacent band writing (hereinafter, may be referred to as the number of times of reverse forward direction adjacent band writing or the number of times of reverse forward direction writing) that data is written to the adjacent band region (hereinafter, may be referred to as a reverse forward direction adjacent band region or a reverse forward direction band region) adjacent to the target band region in the reverse forward direction.

When data is written to an adjacent band region radially adjacent to the target band region, the write count unit 620 increases (increments) the number of times of adjacent band writing by a particular value. For example, when data is written to an adjacent band region located in the radial direction of the target band region, the write count unit 620 increases (increments) the number of times of adjacent band writing by one. When data is written to the forward direction adjacent band region, the write count unit 620 increases (increments) the number of times of forward direction adjacent band writing by a particular value. For example, when data is written to the forward direction adjacent band region, the write count unit 620 increases (increments) the number of times of forward direction adjacent band writing (the number of times of forward direction writing) by one. When data is written to the reverse forward direction adjacent band region, the write count unit 620 increases (increments) the number of times of reverse forward direction adjacent band writing (the number of times of reverse forward direction writing) by a particular value. For example, when data is written to the reverse forward direction adjacent band region, the write count unit 620 increases (increments) the number of times of reverse forward direction adjacent band writing (the number of times of reverse forward direction writing) by one.

The write count unit 620 counts the number of times of writing (hereinafter, may be referred to as the number of times of proximity track writing) that data is written to the track (hereinafter, may be referred to as a proximity track) located within a particular range in the radial direction from the track of target (hereinafter, may be referred to as a target track) or the target band region. The write count unit 620 counts the number of times of proximity track writing (hereinafter, may be referred to as the number of times of forward direction proximity track writing or the number of times of forward direction writing) that data is written to the proximity track (hereinafter, may be referred to as a forward direction proximity track) located within a particular range in the forward direction from the target track or the target band region. The write count unit 620 counts the number of times of proximity track writing (hereinafter, may be referred to as the number of times of reverse forward direction proximity track writing or the number of times of reverse forward direction writing) that data is written to the proximity track (hereinafter, may be referred to as a reverse forward direction proximity track) located within a particular range in the reverse forward direction from the target track or the target band region. It should be noted that when the data is written, a track that exerts influence of writing bleeding, leakage magnetic field, or the like on the target region may be detected by measurement at the manufacturing stage, and the detected track may be set as a proximity track. Further, when the data is written, a track that exerts influence of writing bleeding, leakage magnetic field, or the like on the target region may be detected at the operation process, and the detected track may be set as a proximity track.

When data is written to a proximity track located within a particular range in the radial direction from the target track or the target band region, the write count unit 620 increases (increments) the number of times of proximity track writing by a particular value. For example, when data is written to a proximity track located within a particular range in the radial direction from the target track or the target band region, the write count unit 620 increases (increments) the number of times of proximity track writing by one. When data is written to the forward direction proximity track, the write count unit 620 increases (increments) the number of times of forward direction proximity track writing (the number of times of forward direction writing) by a particular value. For example, when data is written to the forward direction proximity track, the write count unit 620 increases (increments) the number of times of forward direction proximity track writing (the number of times of forward direction writing) by one. When data is written to the reverse forward direction proximity track, the write count unit 620 increases (increments) the number of times of reverse forward direction proximity track writing (the number of times of reverse forward direction writing) by a particular value. For example, when data is written to the reverse forward direction proximity track, the write count unit 620 increases (increments) the number of times of reverse forward direction proximity track writing (the number of times of reverse forward direction writing) by one.

The write count unit 620 counts the number of times of writing (hereinafter, may be referred to as the number of times of adjacent track writing) that data is written to the track (hereinafter, may be referred to as an adjacent track) adjacent to the target track or the target band region in the radial direction. For example, the write count unit 620 counts the number of times of adjacent track writing (hereinafter, may be referred to as or the number of times of forward direction adjacent track writing or the number of times of forward direction writing) that data is written to the adjacent track (hereinafter, may be referred to as a forward direction adjacent track) adjacent to the target track or the target band region in the forward direction. In addition, for example, the write count unit 620 counts the number of times of adjacent track writing (hereinafter, may be referred to as the number of times of reverse forward direction adjacent track writing or the number of times of reverse forward direction writing) that data is written to the adjacent track (hereinafter, may be referred to as a reverse forward direction adjacent track) adjacent to the target track or the target band region in the reverse forward direction.

When data is written to an adjacent track adjacent to the target track or the target band region in the radial direction, the write count unit 620 increases (increments) the number of times of adjacent track writing by a particular value. For example, when data is written to an adjacent track adjacent to the target track or the target band region in the radial direction, the write count unit 620 increases (increments) the number of times of adjacent track writing by one. When data is written to the forward direction adjacent track, the write count unit 620 increases (increments) the number of times of forward direction adjacent track writing (the number of times of forward direction writing) by a particular value. For example, when data is written to the forward direction adjacent track, the write count unit 620 increases (increments) the number of times of forward direction adjacent track writing (the number of times of forward direction writing) by one. When data is written to the reverse forward direction adjacent track, the write count unit 620 increases (increments) the number of times of reverse forward direction adjacent track writing by a particular value. For example, when data is written to the reverse forward direction adjacent track, the write count unit 620 increases (increments) the number of times of reverse forward direction adjacent track writing (the number of times of reverse forward direction writing) by one.

The refresh unit 630 reads data of a particular region and performs a process (hereinafter, may be referred to as saving or a saving process) of writing (or saving) the read data to another region. When data at an end portion of a particular region (hereinafter, may be referred to as a target region) is affected by leakage flux or the like with an amount larger than a specific amount (Adjacent Track Interference (ATI)), the refresh unit 630 performs a saving process on the data at the end portion of the target region in the radial direction. The refresh unit 630 has a threshold value (hereinafter, may be referred to as a saving threshold value) of the number of times of writing corresponding to the target region that is the number of times of writing when the saving process corresponding to the target region is performed. Note that refresh unit 630 may have a plurality of different saving threshold values corresponding to the target regions. The saving threshold value corresponds to the number of times of writing to a region in the radial direction of the target region in which the data of the particular portion of the target region receives ATI larger than a specific amount, for example, the amount that destructs data. For example, the saving threshold value corresponds to the number of times of writing to the region in the radial direction of the target region in which data at the end portion of the target region receives ATI larger than the amount that destroys the data. When determining that the number of times of writing is larger than the saving threshold value corresponding to the target region, the refresh unit 630 performs the saving process on the data at the end portion of the target region. The refresh unit 630 may hold (write) the saving threshold value as a table for each region in a particular recording region, for example, the system area 10c of the disk 10, the volatile memory 70, the non-volatile memory 80, the buffer memory 90, or the like.

The refresh unit 630 executes a process of rewriting the data same as the data written to the target region into the target region (hereinafter, may be referred to as rewrite, rewrite process, refresh, or refresh process) or a process of overwriting or rewriting the data into the target region (hereinafter, may be referred to as an overwrite process, a rewrite process, rewrite, refresh, or a refresh process). Hereinafter, the rewrite process, or the overwriting process may be collectively referred to as rewrite, a rewrite process, refresh, or a refresh process. “Overwrite” includes “write data on data written at a particular position in a particular region” and “write data at the same position in the same region as the data written at the particular position in the particular region”. In addition, the saving process may be referred to as rewrite, a rewrite process, refresh, or a refresh process. When data at a portion away from the end portion of the target region receives ATI larger than a specific amount, the refresh unit 630 performs the refresh process on the target region. The refresh unit 630 has a threshold value (hereinafter, may be referred to as a refresh threshold value) of the number of times of writing corresponding to the target region that is the number of times of writing when the refresh process corresponding to the target region is performed. The refresh threshold value corresponds to the number of times of writing to a region in the radial direction of this region in which data in a portion away from the end portion of the target region receives ATI larger than a specific amount, for example, the amount that destroys the data. The refresh threshold value is larger than the saving threshold value. When determining that the number of times of writing is larger than the refresh threshold value corresponding to the target region, the refresh unit 630 performs the refresh process on the target region. When performing the refresh process on the target region, the refresh unit 630 resets the number of times of writing corresponding to the target region, for example, to zero. The refresh unit 630 may hold the refresh threshold value as a table for each region in a particular recording region, for example, the system area 10c of the disk 10, the volatile memory 70, the non-volatile memory 80, the buffer memory 90, or the like. When the refresh process is performed on the target region and the data at the end portion of the target region cannot be read, the refresh unit 630 may perform the refresh process on the target region using the data at the end portion of the target region saved in the target region and another region by the save process.

For example, when determining that the number of times of writing corresponding to the target band region is larger than the saving threshold value corresponding to this target band region, the refresh unit 630 causes the head 15 to seek to the target band region and saves the initial track located at the end portion of the target band region in the reverse forward direction into the media cache 10b (or the system area 10c). When determining that the number of times of writing corresponding to the target band region is larger than the refresh threshold value corresponding to this target band region, the refresh unit 630 reads respective tracks of the target band region of the user data region 10a, temporarily holds (writes) data of the respective tracks of the target band region in the media cache 10b and reads the data, and performs the refresh process of rewriting the data of the respective tracks of the target band region read from the media cache 10b to the same position of the target band region. When it is determined that the number of times of writing corresponding to the target band region is larger than the refresh threshold value corresponding to the target band region and the initial track of the target band region cannot be read, the refresh unit 630 may read, from the media cache 10b, data of respective tracks other than the initial track of the target band region read from the target band region and temporarily written to the media cache 10b and data of the initial track saved into the media cache 10b by the saving process, and rewrite respective tracks of the target band region.

For example, when determining that the number of times of forward direction writing corresponding to the target band region is larger than the saving threshold value corresponding to this target band region, the refresh unit 630 causes the head 15 to seek to the target band region and saves the last track located at the end portion of the target band region in the forward direction into the media cache 10b (or the system area 10c). When determining that the number of times of forward direction writing corresponding to the target band region is larger than the refresh threshold value corresponding to this target band region, the refresh unit 630 reads respective tracks of the target band region of the user data region 10a, temporarily writes data of the respective tracks of the target band region to the media cache 10b, reads the data from the media cache 10b, and performs the refresh process of rewriting the data read from the media cache 10b to the same position of the target band region. When it is determined that the number of times of forward direction writing corresponding to the target band region is larger than the refresh threshold value corresponding to this target band region and the last track of the target band region cannot be read, the refresh unit 630 may read, from the media cache 10b, data of respective tracks other than the last track of the target band region read from the target band region and temporarily written to the media cache 10b and data of the last track saved into the media cache 10b by the saving process, and rewrite respective tracks of the target band region.

For example, when determining that the number of times of reverse forward direction writing corresponding to the target band region is larger than the saving threshold value corresponding to this target band region, the refresh unit 630 causes the head 15 to seek to the target band region and saves the initial track located at the end portion of the target band region in the reverse forward direction into the media cache 10b (or the system area 10c). When determining that the number of times of reverse forward direction writing corresponding to the target band region is larger than the refresh threshold value corresponding to the target band region, the refresh unit 630 reads respective tracks of the target band region of the user data region 10a, temporarily writes data of the respective tracks of the target band region to the media cache 10b, reads the data from the media cache 10b, and performs the refresh process of rewriting the data read from the media cache 10b to the same position of the target band region. When it is determined that the number of times of reverse forward direction writing corresponding to the target band region is larger than the refresh threshold value corresponding to the target band region and the initial track of the target band region cannot be read, the refresh unit 630 may read, from the media cache 10b, data of respective tracks other than the initial track of the target band region read from the target band region and temporarily written to the media cache 10b and data of the initial track saved into the media cache 10b by the saving process, and rewrite respective tracks of the target band region.

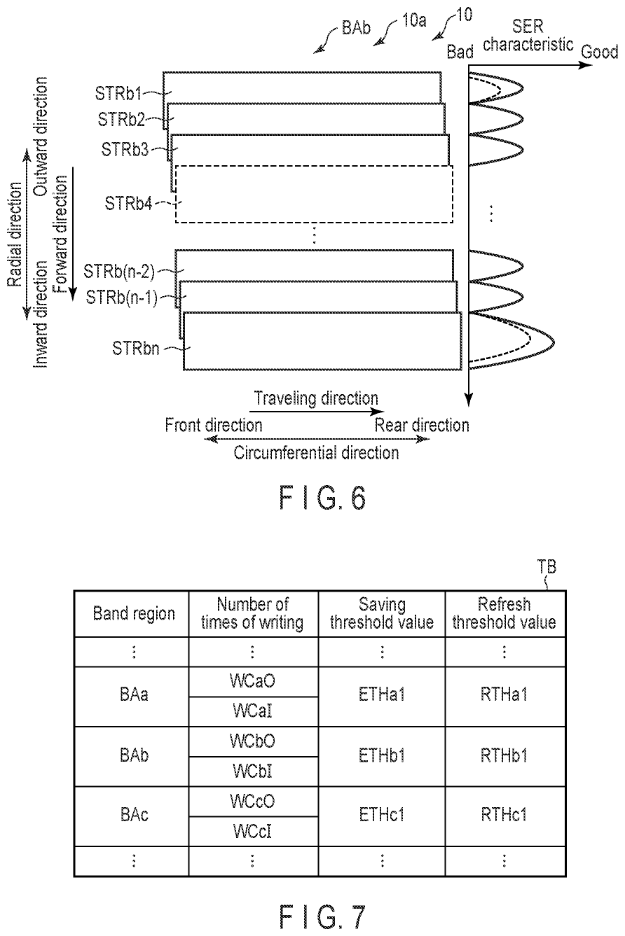

FIG. 6 is a schematic diagram illustrating an example of a sector error rate (SER) characteristic of each track in the band region. FIG. 6 illustrates the band region BAb illustrated in FIG. 5 and sector error rate (SER) characteristics of each track of the band region BAb. The band region BAb includes tracks STRb1, STRb2, STRb3, STRb4, . . . , STRb(n−2), STRb(n−1), and STRbn. In the band region BAb, the tracks STRb1, STRb2, STRb3, STRb4, . . . , STRb(n−2), STRb(n−1), and

STRbn are continuously disposed in the forward direction in the described order. The track STRb1 corresponds to the initial track, and the track STRbn corresponds to the last track. In FIG. 6, the vertical axis represents the radial direction (radial position), and the horizontal axis represents the SER characteristic. In the vertical axis of FIG. 6, the radial position proceeds in the forward direction as it proceeds toward the tip side of the arrow. In the horizontal axis of FIG. 6, the SER characteristic is better toward the tip side of the arrow, and is worse toward the side opposite to the tip side of the arrow. As the SER characteristics deteriorate, the possibility of data destruction increases. In the SER characteristic of FIG. 6, a solid line indicates the SER characteristic of the track that has not received ATI, and a broken line indicates the SER characteristic of the track that has received ATI.

For example, when data is written a particular number of times to the band region BAa illustrated in FIG. 5, as illustrated in FIG. 6, the SER characteristic of the initial track located at the end portion of the band region BAb in the reverse forward direction changes from the SER characteristic indicated by the solid line to the SER characteristic indicated by the broken line by ATI. When data is written to the band region BAa illustrated in FIG. 5 a plurality of times, in the example illustrated in FIG. 6, the SER characteristics of tracks other than the initial track located at the end portion of the band region BAb in the reverse forward direction are not changed by ATI. Note that, in a case where data is written to the band region BAa illustrated in FIG. 5 the number of times larger than the particular number of times, the SER characteristic of the track other than the initial track located at the end portion of the band region BAb in the reverse forward direction can be changed by ATI.

For example, when data is written to the band region BAc illustrated in FIG. 5 a particular number of times, as illustrated in FIG. 6, the SER characteristic of the last track located at the end portion of the band region BAb in the forward direction changes from the SER characteristic indicated by the solid line to the SER characteristic indicated by the broken line by ATI. When data is written to the band region BAc illustrated in FIG. 5 a particular number of times, in the example illustrated in FIG. 6, the SER characteristics of tracks other than the last track located at the end portion of the band region BAb in the forward direction are not changed by ATI. Note that, when data is written to the band region BAa illustrated in FIG. 5 the number of times larger than the particular number of times, the SER characteristics of tracks other than the last track located at the end portion of the band region BAb in the forward direction can be changed by ATI.

FIG. 7 is a schematic diagram illustrating an example of a table TB of the number of times of writing, a saving threshold value, and a refresh threshold value according to the present embodiment. In FIG. 7, the table TB includes band regions BAa, BAb, and BAc, the number of times of writing WaO, WCaI, WCbO, WCbI, WCcO, and WCcI, saving threshold values ETHa1, ETHb1, and ETHc1, and refresh threshold values RTHa1, RTHb1, and RTHc1. The table TB is recorded in, for example, a particular recording region, for example, the system area 10c of the disk 10, the volatile memory 70, the non-volatile memory 80, the buffer memory 90, or the like. The band regions BAa, BAb, and BAc correspond to FIG. 5. In the table TB of FIG. 7, the number of times of writing WCaO and WCaI correspond to the band region BAa, the saving threshold value ETHa1 corresponds to the band region BAa, and the refresh threshold value RTHa1 corresponds to the band region BAa. The number of times of writing WCaO corresponds to the number of times of reverse forward direction writing (the number of times of reverse forward direction band writing). The number of times of writing WCaI corresponds to the number of times of forward direction writing (the number of times of forward direction adjacent band writing). In the table TB of FIG. 7, the number of times of writing WCbO and WCbI correspond to the band region BAb, the saving threshold value ETHb1 corresponds to the band region BAb, and the refresh threshold value RTHb1 corresponds to the band region BAb. The number of times of writing WCbO corresponds to the number of times of reverse forward direction writing (the number of times of reverse forward direction adjacent band writing). The number of times of writing WCbI corresponds to the number of times of forward direction writing (the number of times of forward direction adjacent band writing). In the table TB of FIG. 7, the number of times of writing WCcO and WCcI correspond to the band region BAc, the saving threshold value ETHc1 corresponds to the band region BAc, and the refresh threshold value RTHc1 corresponds to the band region BAc. The number of times of writing WCcO corresponds to the number of times of reverse forward direction writing (the number of times of reverse forward direction adjacent band writing). The number of times of writing WCcI corresponds to the number of times of forward direction writing (the number of times of forward direction adjacent band writing).

In the example illustrated in FIG. 7, when data is written in the reverse forward direction of the band region BAa, for example, in the outer band region, the MPU 60 increases the number of times of reverse forward direction writing (the number of times of reverse forward direction adjacent band writing) WCaO corresponding to the band region BAa by one.

In a case where it is determined that the number of times of reverse forward direction writing (the number of times of reverse forward direction adjacent band writing) WCaO is larger than the saving threshold value ETHa1, the MPU 60 causes the head 15 to seek to the band region BAa, reads the initial track of the band region BAa, and saves (or writes) data of the initial track into the media cache 10b.

When determining that the number of times of reverse forward direction writing (the number of times of reverse forward direction adjacent band writing) WCaO is larger than the refresh threshold value RTHa1, the MPU 60 performs the refresh process on the band region BAa.

In the example illustrated in FIG. 7, when data is written in the forward direction of the band region BAa, for example, the inner band region BAb, the MPU 60 increments the number of times of forward direction writing (the number of times of forward direction adjacent band writing) WCaI corresponding to the band region BAa by one.

When determining that number of times of forward direction writing WCaI is larger than the saving threshold value ETHa1, the MPU 60 causes the head 15 to seek to the band region BAa, reads the last track of the band region BAa, and saves (or writes) the data of the last track into the media cache 10b.

When determining that the number of times of forward direction writing (the number of times of forward direction adjacent band writing) WCaI is larger than the refresh threshold value RTHa1, the MPU 60 performs the refresh process on the band region BAa.

In the example illustrated in FIG. 7, when data is written in the reverse forward direction of the band region BAb, for example, in the outer band region BAa, the MPU 60 increases the number of times of reverse forward direction writing (the number of times of reverse forward direction adjacent band writing) WCbO corresponding to the band region BAb by one.

When determining that the number of times of reverse forward direction writing (the number of times of reverse forward direction adjacent band writing) WCbO is larger than the saving threshold value ETHb1, the MPU 60 causes the head 15 to seek to the band region BAb, reads the initial track of the band region BAb, and saves (or writes) the data of the initial track into the media cache 10b.

When determining that the number of times of reverse forward direction writing (the number of times of reverse forward direction adjacent band writing) WCbO is larger than the refresh threshold value RTHb1, the MPU 60 performs the refresh process on the band region BAb.

In the example illustrated in FIG. 7, when data is written in the forward direction of the band region BAb, for example, the inner band region BAc, the MPU 60 increases the number of times of forward direction writing (the number of times of forward direction adjacent band writing) WCbI corresponding to the band region BAb by one.

When determining that the number of times of forward direction writing WCbI is larger than the saving threshold value ETHb1, the MPU 60 causes the head 15 to seek to the band region BAb, reads the last track of the band region BAb, and saves (or writes) the data of the last track into the media cache 10b.

When determining that the number of times of forward direction writing (the number of times of forward direction adjacent band writing) WCbI is larger than the refresh threshold value RTHb1, the MPU 60 performs the refresh process on the band region BAb.

In the example illustrated in FIG. 7, when data is written in the reverse forward direction of the band region BAc, for example, the outer band region BAb, the MPU 60 increases the number of times of reverse forward direction writing (the number of times of reverse forward direction adjacent band writing) WCcO corresponding to the band region BAc by one.

When determining that the number of times of reverse forward direction writing (the number of times of reverse forward direction adjacent band writing) WCcO is larger than the saving threshold value ETHc1, the MPU 60 causes the head 15 to seek to the band region BAc, reads the initial track of the band region BAc, and saves (or writes) the data of the initial track into the media cache 10b.

When determining that the number of times of reverse forward direction writing (the number of times of reverse forward direction adjacent band writing) WCcO is larger than the refresh threshold value RTHc1, the MPU 60 performs the refresh process on the band region BAc.

In the example illustrated in FIG. 7, when data is written in the forward direction of the band region BAc, for example, in the inner band region, the MPU 60 increases the number of times of forward direction writing (the number of times of forward direction adjacent band writing) WCcI corresponding to the band region BAc by one.

When determining that the number of times of forward direction writing WCcI is larger than the saving threshold value ETHc1, the MPU 60 causes the head 15 to seek to the band region BAc, reads the last track of the band region BAc, and saves (or writes) the data of the last track into the media cache 10b.

When determining that the number of times of forward direction writing (the number of times of forward direction adjacent band writing) WCcI is larger than the refresh threshold value RTHc1, the MPU 60 performs the refresh process on the band region BAc.

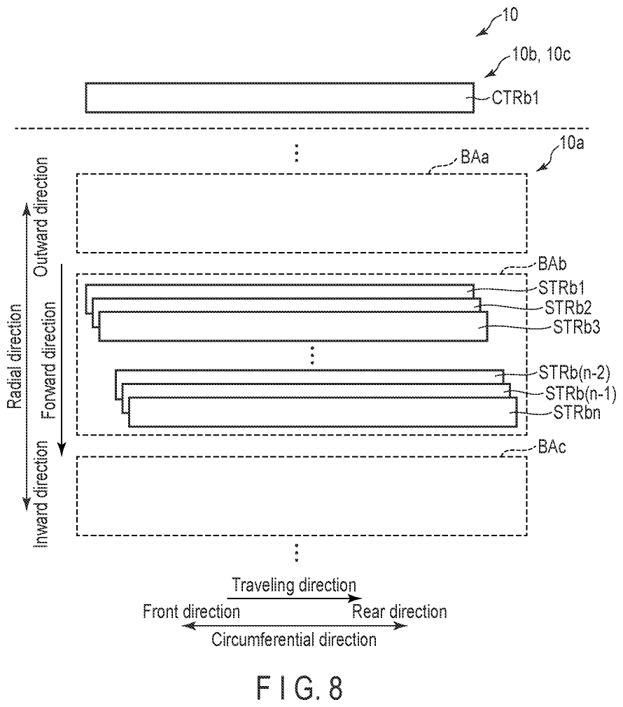

FIG. 8 is a schematic diagram illustrating an example of a saving processing method and a refresh processing method according to the present embodiment. FIG. 8 corresponds to FIG. 5. FIG. 8 illustrates the initial track CTRb1. The track CTRb1 corresponds to the track STRb1. The data of the track CTRb1 corresponds to the data of the track STRb1.

In the example illustrated in FIG. 8, when data is written to the band region BAa, the MPU 60 increases the number of times of reverse forward direction writing corresponding to the band region BAb by one. When determining that the number of times of reverse forward direction writing corresponding to the band region BAb is larger than the saving threshold value corresponding to the band region BAb, the MPU 60 causes the head 15 to seek to the band region BAb, reads the initial track STRb1 of the band region BAb, and saves (or writes) the data of the initial track STRb1 as the track CTRb1 into the media cache 10b (or the system area 10c). When determining that the number of times of reverse forward direction writing corresponding to the band region BAb is larger than the refresh threshold value corresponding to the band region BAb, the MPU 60 reads the tracks STRb1 to STRbn from the band region BAb, temporarily writes the data of the tracks STRb1 to STRbn to the media cache 10b, reads the data from the media cache 10b, and rewrites the data read from the media cache 10b to the band region BAb. Note that when it is determined that the number of times of reverse forward direction writing corresponding to the band region BAb is larger than the refresh threshold value corresponding to the band region BAb, and the initial track STRb1 cannot be read, the MPU 60 may read the track CTRb1 and the data of the tracks STRb2 to STRbn from the media cache 10b, and rewrite the data of the tracks STRb1 to STRbn to the band region BAb.

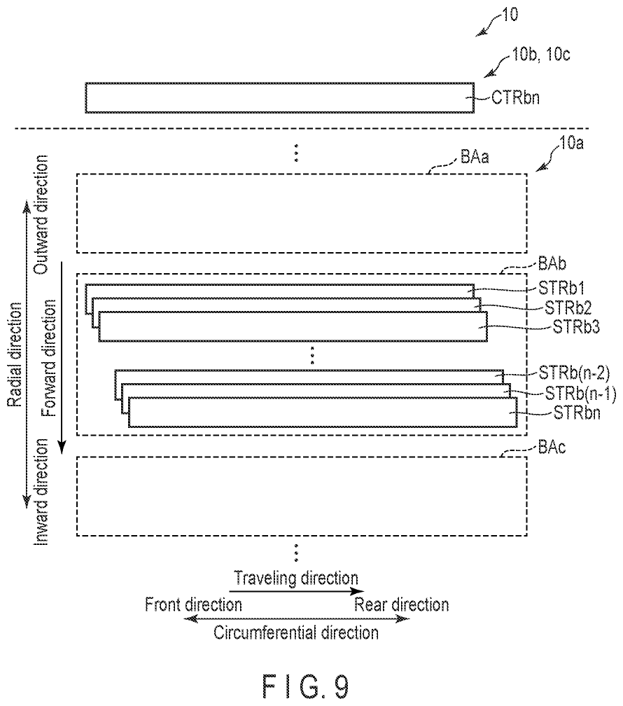

FIG. 9 is a schematic diagram illustrating an example of a saving processing method and a refresh processing method according to the present embodiment. FIG. 9 corresponds to FIG. 5. FIG. 9 illustrates the last track CTRbn. The track CTRbn corresponds to the track STRbn. The data of the track CTRbn corresponds to the data of the track STRbn.

In the example illustrated in FIG. 9, when data is written to the band region BAc, the MPU 60 increases the number of times of forward direction writing corresponding to the band region BAb by one. When determining that the number of times of forward direction writing corresponding to the band region BAb is larger than the saving threshold value corresponding to the band region BAb, the MPU 60 causes the head 15 to seek to the band region BAb, reads the last track STRbn of the band region BAb, and saves (or writes) the data of the last track STRbn as the track CTRbn into the media cache 10b (or the system area 10c). When determining that the number of times of forward direction writing corresponding to the band region BAb is larger than the refresh threshold value corresponding to the band region BAb, the MPU 60 reads the tracks STRb1 to STRbn from the band region BAb, temporarily writes the data of the tracks STRb1 to STRbn to the media cache 10b, reads the data from the media cache 10b, and rewrites the data read from the media cache 10b to the band region BAb. When it is determined that the number of times of forward direction writing corresponding to the band region BAb is larger than the refresh threshold value and the last track STRbn cannot be read, the MPU 60 may read the track CTRbn and the data of the tracks STRb1 to STRb(n−1) from the media cache 10b and rewrite the data of the tracks STRb1 to STRbn to the band region BAb.

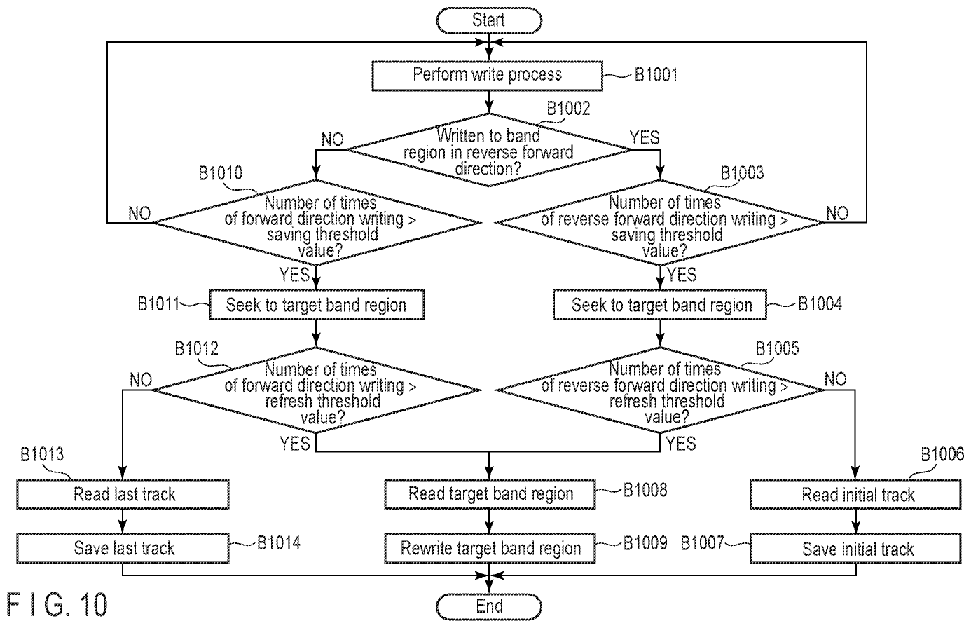

FIG. 10 is a flowchart showing an example of the refresh processing method according to the present embodiment.

The MPU 60 receives a command from the host 100 and executes a write process (B1001). The MPU 60 determines whether data is written to the band region in the reverse forward direction of the target band region (B1002). In other words, the MPU 60 determines whether data is written to the band region in the reverse forward direction of the target band region or data is written to the band region in the forward direction of the target band region.

When it is determined that the data is written to the band region in the reverse forward direction of the target band region (YES in B1002), the MPU 60 determines whether the number of times of reverse forward direction writing is larger than the saving threshold value corresponding to the target band region or equal to or less than the saving threshold value corresponding to the target band region (B1003). When it is determined that the number of times of reverse forward direction writing is equal to or less than the saving threshold value corresponding to the target band region (NO in B1003), the MPU 60 advances the process to B1001. When it is determined that the number of times of reverse forward direction writing is larger than the saving threshold value corresponding to the target band region (YES in B1003), the MPU 60 causes the head 15 to seek to the target band region (B1004).

The MPU 60 determines whether the number of times of reverse forward direction writing is larger than the refresh threshold value corresponding to the target band region or equal to or less than the refresh threshold value corresponding to the target band region (B1005). When it is determined that the number of times of reverse forward direction writing is equal to or less than the refresh threshold value corresponding to the target band region (NO in B1005), the MPU 60 reads the initial track of the target band region (B1006), saves the read initial track into the media cache 10b (B1007), and ends the process.

When it is determined that the number of times of reverse forward direction writing is larger than the refresh threshold value corresponding to the target band region (YES in B1005), the MPU 60 reads all tracks in the target band region (B1008), temporarily writes data of all the tracks in the target band region to the media cache 10b, reads the data from the media cache 10b, rewrites the data read from the media cache 10b to the target band region (B1009), and ends the process.

When it is determined that the data is not written to the band region in the reverse forward direction of the target band region, that is, the data is written to the band region in the forward direction of the target band region (NO in B1002), the MPU 60 determines whether the number of times of forward direction writing is larger than the saving threshold value corresponding to the target band region or equal to or less than the saving threshold value corresponding to the target band region (B1010). When it is determined that the number of times of forward direction writing is equal to or less than the saving threshold value corresponding to the target band region (NO in B1010), the MPU 60 advances the process to B1001. When it is determined that the number of times of forward direction writing is larger than the saving threshold value corresponding to the target band region (YES in B1010), the MPU 60 causes the head 15 to seek to the target band region (B1011).

The MPU 60 determines whether the number of times of forward direction writing is larger than the refresh threshold value corresponding to the target band region or equal to or less than the refresh threshold value corresponding to the target band region (B1012). When determining that the number of times of forward direction writing is equal to or less than the refresh threshold value corresponding to the target band region (NO in B1012), the MPU 60 reads the last track of the target band region (B1013), saves the read last track into the media cache 10b (B1014), and ends the process.

When it is determined that the number of times of forward direction writing is larger than the refresh threshold value corresponding to the target band region (YES in B1012), the MPU 60 advances the process to B1008.

According to the present embodiment, the magnetic disk device 1 has a threshold value regarding a plurality of different write counts for each particular region, for example, for each band region. The magnetic disk device 1 has a saving threshold value and a refresh threshold value for each particular region, for example, for each band region. When determining that the number of times of reverse forward direction writing is larger than the saving threshold value corresponding to the target band region, the magnetic disk device 1 causes the head 15 to seek to the target band region. When determining that the number of times of reverse forward direction writing is equal to or less than the refresh threshold value corresponding to the target band region, the magnetic disk device 1 reads the initial track of the target band region and saves the read initial track into the media cache 10b. When determining that the number of times of reverse forward direction writing is larger than the refresh threshold value corresponding to the target band region, the magnetic disk device 1 reads all tracks in the target band region, temporarily writes data of all the tracks in the target band region to the media cache 10b, reads the data from the media cache 10b, and rewrites the data read from the media cache 10b to the target band region. When determining that the number of times of forward direction writing is larger than the saving threshold value corresponding to the target band region, the magnetic disk device 1 causes the head 15 to seek to the target band region. When determining that the number of times of forward direction writing is equal to or less than the refresh threshold value corresponding to the target band region, the magnetic disk device 1 reads the last track of the target band region and saves the read last track into the media cache 10b. When determining that the number of times of forward direction writing is larger than the refresh threshold value corresponding to the target band region, the magnetic disk device 1 reads all tracks in the target band region, temporarily writes data of all the tracks in the target band region to the media cache 10b, reads the data from the media cache 10b, and rewrites the data read from the media cache 10b to the target band region. Since the magnetic disk device 1 has the saving threshold value and the refresh threshold value for each band region, it is possible to perform the saving process of the initial track or the last track of the target band region that receives ATI most when data is written to the adjacent band region of the target band region before performing the refresh process. The magnetic disk device 1 can set a refresh threshold value larger than a refresh threshold value corresponding to the conventional refresh process in which only one refresh threshold value is set for the target band region. Therefore, the magnetic disk device 1 can reduce the ratio (hereinafter, may be referred to as a frequency of the refresh process) of performing the refresh process at particular time intervals. Therefore, the magnetic disk device 1 can improve performance.

Next, a magnetic disk device according to modifications of the first embodiment and another embodiment will be described. In the modifications and another embodiment, the same reference numerals are attached to the same parts as those in the first embodiment, and a detailed description thereof will be omitted.

(Modification 1)

The magnetic disk device 1 according to Modification 1 of the first embodiment is different from the magnetic disk device 1 according to the first embodiment described above in the refresh processing method.

For example, when determining that the number of times of adjacent band writing corresponding to the target band region is larger than the saving threshold value corresponding to this target band region, the refresh unit 630 causes the head 15 to seek to the target band region and saves the initial track of the target band region into the media cache 10b (or the system area 10c). When determining that the number of times of adjacent band writing corresponding to the target band region is larger than the refresh threshold value corresponding to this target band region, the refresh unit 630 reads respective tracks other than the initial track of the target band region of the user data region 10a and temporarily writes data of the respective tracks other than the initial track of the target band region to the media cache 10b. The refresh unit 630 reads, from the media cache 10b, the data of respective tracks other than the initial track of the target band region read from the target band region and temporarily written to the media cache 10b and the data of the initial track saved in the media cache 10b by the saving process, and rewrites the data of the respective tracks other than the initial track of the target band region and the data of the initial track to the target band region.

For example, when determining that the number of times of forward direction adjacent band writing corresponding to the target band region is larger than the saving threshold value corresponding to this target band region, the refresh unit 630 causes the head 15 to seek to the target band region and saves the last track of the target band region into the media cache 10b (or the system area 10c). When determining that the number of times of forward direction adjacent band writing corresponding to the target band region is larger than the refresh threshold value corresponding to the target band region, the refresh unit 630 reads respective tracks other than the last track of the target band region of the user data region 10a and temporarily writes data of the respective tracks other than the last track of the target band region to the media cache 10b. The refresh unit 630 reads, from the media cache 10b, the data of respective tracks other than the last track of the target band region read from the target band region and temporarily written to the media cache 10b and the data of the last track saved into the media cache 10b by the saving process, and rewrites the data of respective tracks other than the last track of the target band region and the data of the last track to the target band region.

For example, when determining that the number of times of reverse forward direction writing corresponding to the target band region is larger than the saving threshold value corresponding to this target band region, the refresh unit 630 causes the head 15 to seek to the target band region and saves the initial track of the target band region into the media cache 10b (or the system area 10c). When determining that the number of times of reverse forward direction adjacent band writing corresponding to the target band region is larger than the refresh threshold value corresponding to this target band region, the refresh unit 630 reads respective tracks other than the initial track of the target band region of the user data region 10a and temporarily writes data of the respective tracks other than the initial track of the target band region to the media cache 10b. The refresh unit 630 reads, from the media cache 10b, the data of respective tracks other than the initial track of the target band region read from the target band region and temporarily written to the media cache 10b and the data of the initial track saved in the media cache 10b by the saving process, and rewrites the data of the respective tracks other than the initial track of the target band region and the data of the initial track to the target band region.

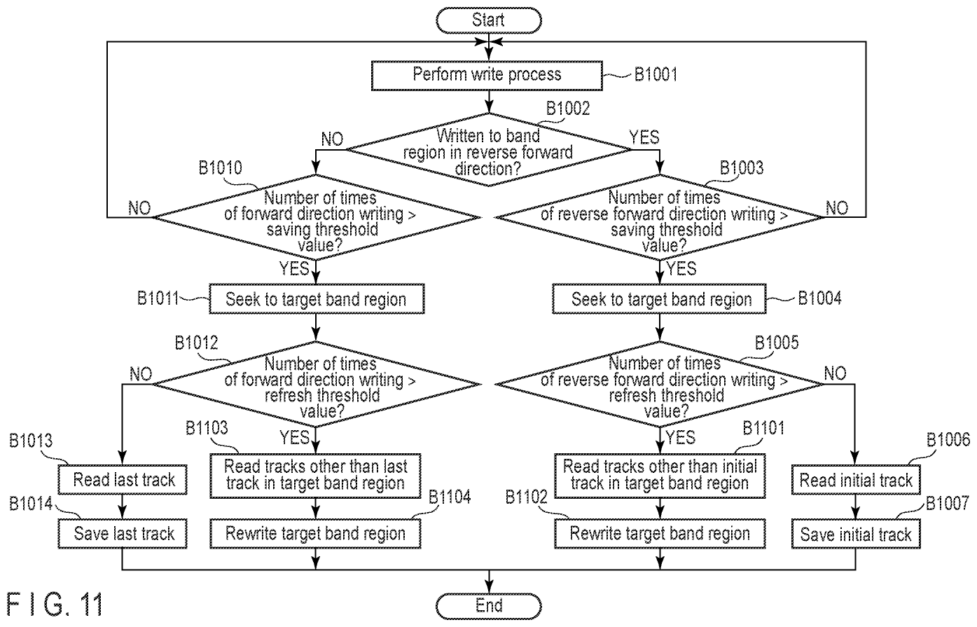

FIG. 11 is a flowchart showing an example of the refresh processing method according to Modification 1.

The MPU 60 executes a write process in response to a command from the host 100 (B1001), and determines whether data is written to the band region in the reverse forward direction of the target band region (B1002).

When it is determined that the data is written to the band region in the reverse forward direction of the target band region (YES in B1002), the MPU 60 determines whether the number of times of reverse forward direction writing is larger than the saving threshold value corresponding to the target band region or equal to or less than the saving threshold value corresponding to the target band region (B1003). When it is determined that the number of times of reverse forward direction writing is equal to or less than the saving threshold value corresponding to the target band region (NO in B1003), the MPU 60 advances the process to B1001. When it is determined that the number of times of reverse forward direction writing is larger than the saving threshold value corresponding to the target band region (YES in B1003), the MPU 60 causes the head 15 to seek to the target band region (B1004).

The MPU 60 determines whether the number of times of reverse forward direction writing is larger than the refresh threshold value corresponding to the target band region or equal to or less than the refresh threshold value corresponding to the target band region (B1005). When it is determined that the number of times of reverse forward direction writing is equal to or less than the refresh threshold value corresponding to the target band region (NO in B1005), the MPU 60 advances the process to B1006.

When determining that the number of times of reverse forward direction writing is larger than the refresh threshold value corresponding to the target band region (YES in B1005), the MPU 60 reads respective tracks other than the initial track of the target band region (B1101), and temporarily writes the respective tracks other than the initial track of the target band region to the media cache 10b. The MPU 60 reads the data of respective tracks other than the initial track of the target band region and the data of the initial track saved by the saving process from the media cache 10b, rewrites the target band region with the previous save data of the initial track and the data of B1101 (B1102), and ends the process.

When it is determined that the data is written to the forward direction band region of the target band region (NO in B1002), the MPU 60 determines whether the number of times of forward direction writing is larger than the saving threshold value corresponding to the target band region or equal to or less than the saving threshold value corresponding to the target band region (B1010). When it is determined that the number of times of forward direction writing is equal to or less than the saving threshold value corresponding to the target band region (NO in B1010), the MPU 60 advances the process to B1001. When it is determined that the number of times of forward direction writing is larger than the saving threshold value corresponding to the target band region (YES in B1010), the MPU 60 causes the head 15 to seek to the target band region (B1011).

The MPU 60 determines whether the number of times of forward direction writing is larger than the refresh threshold value corresponding to the target band region or equal to or less than the refresh threshold value corresponding to the target band region (B1012). When it is determined that the number of times of forward direction writing is equal to or less than the refresh threshold value corresponding to the target band region (NO in B1012), the MPU 60 advances the process to B1013.

When determining that the number of times of forward direction writing is larger than the refresh threshold value corresponding to the target band region (YES in B1012), the MPU 60 reads respective tracks other than the last track of the target band region (B1103), and temporarily writes the respective tracks other than the last track of the target band region to the media cache 10b. The MPU 60 reads the data of respective tracks other than the last track of the target band region and the data of the last track saved by the saving process from the media cache 10b, rewrites the target band region with the previous save data of the last track and the data of B1103 (B1104), and ends the process.

According to Modification 1, when determining that the number of times of reverse forward direction writing is larger than the refresh threshold value corresponding to the target band region, the magnetic disk device 1 reads respective tracks other than the initial track of the target band region, and temporarily writes the respective tracks other than the initial track of the target band region to the media cache 10b. The magnetic disk device 1 reads the data of respective tracks other than the initial track in the target band region and the data of the initial track saved by the saving process from the media cache 10b, and rewrites the data of the respective tracks other than the initial track in the target band region and the data of the initial track to the target band region. In addition, when determining that the number of times of forward direction writing is larger than the refresh threshold value corresponding to the target band region, the magnetic disk device 1 reads respective tracks other than the last track of the target band region and temporarily writes the respective tracks other than the last track of the target band region to the media cache 10b. The magnetic disk device 1 reads the data of respective tracks other than the last track in the target band region and the data of the last track saved by the saving process from the media cache 10b, and rewrites the data of the respective tracks other than the last track in the target band region and the data of the last track to the target band region. When performing the refresh process on the target band region, the magnetic disk device 1 does not need to read the data of the initial track or the data of the last track saved in the save processing again to temporarily write the data to the media cache 10b. Therefore, the magnetic disk device 1 can improve the performance.

(Modification 2)

The magnetic disk device 1 according to Modification 2 of the first embodiment is different from the magnetic disk device 1 according to the first embodiment and Modification 1 described above in terms of the saving threshold value and the refresh threshold value.

When determining that the number of times of writing to the region in the reverse forward direction corresponding to the target region (the number of times of reverse forward direction writing) is larger than the saving threshold value (hereinafter, may be referred to as a reverse forward direction saving threshold value) corresponding to the number of times of writing to the region in the reverse forward direction corresponding to the target region, the refresh unit 630 performs the saving process on the data at the end portion of the target region in the reverse forward direction. The refresh unit 630 may hold the reverse forward direction saving threshold value as a table for each region in the particular recording region, for example, the system area 10c of the disk 10, the volatile memory 70, the non-volatile memory 80, the buffer memory 90, or the like.

When determining that the number of times of writing to the region in the forward direction corresponding to the target region (the number of times of forward direction writing) is larger than the saving threshold value (hereinafter, may be referred to as a forward direction saving threshold value) corresponding to the number of times of writing to the region in the forward direction of the target region, the refresh unit 630 performs the save processing on the data at the end portion of the target region in the forward direction. The forward direction saving threshold value and the reverse forward direction saving threshold value may be different or the same. The refresh unit 630 may hold the forward direction saving threshold value as a table for each region in the particular recording region, for example, the system area 10c of the disk 10, the volatile memory 70, the non-volatile memory 80, the buffer memory 90, or the like.

When determining that the number of times of reverse forward direction writing corresponding to the target region is larger than the refresh threshold value (hereinafter, may be referred to as a reverse forward direction refresh threshold value) corresponding to the number of times of writing to the region in the reverse forward direction corresponding to the target region, the refresh unit 630 performs the refresh process on the target region. The reverse forward direction refresh threshold value is larger than, for example, the reverse forward direction saving threshold value. When performing the refresh process on the target region, the refresh unit 630 resets the number of times of reverse forward direction writing and the number of times of forward direction writing corresponding to the target region, for example, to zero. The refresh unit 630 may hold the reverse forward direction refresh threshold value as a table for each region in the particular recording region, for example, the system area 10c of the disk 10, the volatile memory 70, the non-volatile memory 80, the buffer memory 90, or the like. When the refresh process is performed on the target region and the data at the end portion of the target region in the reverse forward direction cannot be read, the refresh unit 630 may perform the refresh process on the target region by using the data at the end portion of the target region in the reverse forward direction saved in the target region and another region by the save processing.

When determining that the number of times of forward direction writing corresponding to the target region is larger than the refresh threshold value (hereinafter, may be referred to as a forward direction refresh threshold value) corresponding to the number of times of writing to the region in the forward direction of the target region, the refresh unit 630 performs the refresh process on the target region. The forward direction refresh threshold value is larger than, for example, the forward direction saving threshold value. The forward direction refresh threshold value and the reverse forward direction refresh threshold value may be the same or different. When performing the refresh process on the target region, the refresh unit 630 resets the number of times of reverse forward direction writing and the number of times of forward direction writing corresponding to the target region, for example, to zero. The refresh unit 630 may hold the forward direction refresh threshold value as a table for each region in the particular recording region, for example, the system area 10c of the disk 10, the volatile memory 70, the non-volatile memory 80, the buffer memory 90, or the like. When the refresh process is performed on the target region and the data at the end portion of the target region in the forward direction cannot be read, the refresh unit 630 may perform the refresh process on the target region by using the data at the end portion of the target region in the forward direction saved in the target region and another region by the save processing.

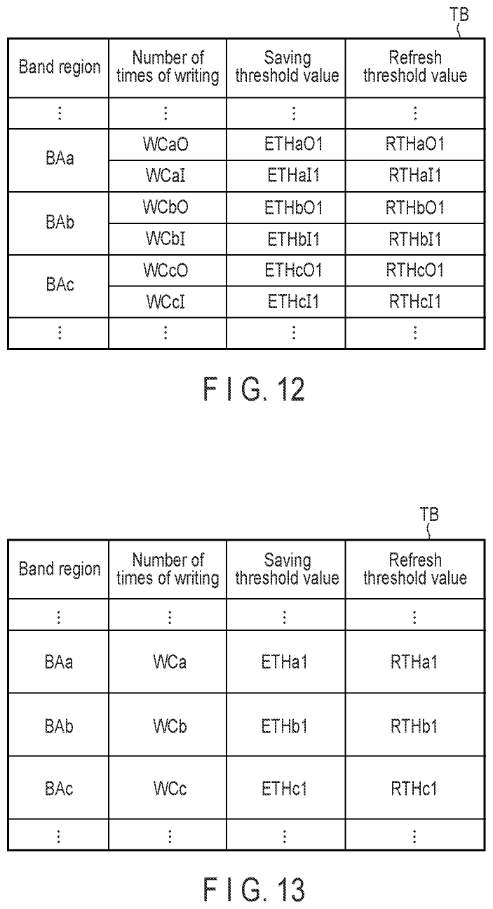

FIG. 12 is a schematic diagram illustrating an example of a table TB of the number of times of writing, a saving threshold value, and a refresh threshold value according to Modification 2. In FIG. 12, the table TB includes band regions BAa, BAb, and BAc, saving threshold values ETHaO1, ETHaI1, ETHbO1, ETHbI1, ETHcO1, and ETHcI1, and refresh threshold values RTHaO1, RTHaI1, RTHbO1, RTHbI1, RTHcO1, and RTHcI1. The table TB is recorded in, for example, a particular recording region, for example, the system area 10c of the disk 10, the volatile memory 70, the non-volatile memory 80, the buffer memory 90, or the like. The band regions BAa, BAb, and BAc correspond to FIG. 5. In the table TB of FIG. 12, the saving threshold values ETHaO1 and ETHaI1 correspond to the band region BAa, and the refresh threshold values RTHaO1 and RTHaI1 correspond to the band region BAa. The saving threshold value ETHaO1 corresponds to a reverse forward direction saving threshold value, and the saving threshold value ETHaI1 corresponds to a forward direction saving threshold value. The refresh threshold value RTHaO1 corresponds to a reverse forward direction refresh threshold value, and the refresh threshold value RTHaI1 corresponds to a forward direction refresh threshold value. In the table TB of FIG. 12, the saving threshold values ETHbO1 and ETHbI1 correspond to the band region BAb, and the refresh threshold values RTHbO1 and RTHbI1 correspond to the band region BAb. The saving threshold value ETHbO1 corresponds to a reverse forward direction saving threshold value, and the saving threshold value ETHbI1 corresponds to a forward direction saving threshold value. The refresh threshold value RTHbO1 corresponds to a reverse forward direction refresh threshold value, and the refresh threshold value RTHbI1 corresponds to a forward direction refresh threshold value. In the table TB of FIG. 12, the saving threshold values ETHcO1 and ETHcI1 correspond to the band region BAc, and the refresh threshold values RTHcO1 and RTHcI1 correspond to the band region BAc. The saving threshold value ETHcO1 corresponds to a reverse forward direction saving threshold value, and the saving threshold value ETHcI1 corresponds to a forward direction saving threshold value. The refresh threshold value RTHcO1 corresponds to a reverse forward direction refresh threshold value, and the refresh threshold value RTHcI1 corresponds to a forward direction refresh threshold value.

In the example illustrated in FIG. 12, when data is written in the reverse forward direction of the band region BAa, for example, in the outer band region, the MPU 60 increases the number of times of reverse forward direction writing (the number of times of reverse forward direction adjacent band writing) WCaO corresponding to the band region BAa by one.

When determining that the number of times of reverse forward direction writing (the number of times of reverse forward direction adjacent band writing) WCaO is larger than the reverse forward direction saving threshold value ETHaO1, the MPU 60 causes the head 15 to seek to the band region BAa, reads the initial track of the band region BAa, and saves (or writes) data of the initial track into the media cache 10b.

When determining that the number of times of reverse forward direction writing (the number of times of reverse forward direction adjacent band writing) WCaO is larger than the reverse forward direction refresh threshold value RTHaO1, the MPU 60 performs the refresh process on the band region BAa.

In the example illustrated in FIG. 12, when data is written in the forward direction of the band region BAa, for example, the inner band region BAb, the MPU 60 increases the number of times of forward direction writing (the number of times of forward direction adjacent band writing) WCaI corresponding to the band region BAa by one.

When determining that the number of times of forward direction writing WCaI is larger than the forward direction saving threshold value ETHaI1, the MPU 60 causes the head 15 to seek to the band region BAa, reads the last track of the band region BAa, and saves (or writes) the data of the last track into the media cache 10b.

When determining that the number of times of forward direction writing (the number of times of forward direction adjacent band writing) WCaI is larger than the forward direction refresh threshold value RTHaI1, the MPU 60 performs the refresh process on the band region BAa.

In the example illustrated in FIG. 12, when data is written in the reverse forward direction of the band region BAb, for example, in the outer band region BAa, the MPU 60 increases the number of times of reverse forward direction writing (the number of times of reverse forward direction adjacent band writing) WCaO corresponding to the band region BAb by one.

When determining that the number of times of reverse forward direction writing (the number of times of reverse forward direction adjacent band writing) WCbO is larger than the reverse forward direction saving threshold value ETHbO1, the MPU 60 causes the head 15 to seek to the band region BAb, reads the initial track of the band region BAb, and saves (or writes) the data of the initial track into the media cache 10b.

When determining that the number of times of reverse forward direction writing (the number of times of reverse forward direction adjacent band writing) WCbO is larger than the reverse forward direction refresh threshold value RTHbO1, the MPU 60 performs the refresh process on the band region BAb.

In the example illustrated in FIG. 12, when data is written in the forward direction of the band region BAb, for example, the inner band region BAc, the MPU 60 increases the number of times of forward direction writing (the number of times of forward direction adjacent band writing) WCbI corresponding to the band region BAb by one.

When determining that the number of times of forward direction writing WCbI is larger than the forward direction saving threshold value ETHbI1, the MPU 60 causes the head 15 to seek to the band region BAb, reads the last track of the band region BAb, and saves (or writes) the data of the last track into the media cache 10b.

When determining that the number of times of forward direction writing (the number of times of forward direction adjacent band writing) WCbI is larger than the forward direction refresh threshold value RTHbI1, the MPU 60 performs the refresh process on the band region BAb.

In the example illustrated in FIG. 12, when data is written in the reverse forward direction of the band region BAc, for example, in the outer band region BAb, the MPU 60 increases the number of times of reverse forward direction writing (the number of times of reverse forward direction adjacent band writing) WCcO corresponding to the band region BAc by one.

When determining that the number of times of reverse forward direction writing (the number of times of reverse forward direction adjacent band writing) WCcO is larger than the reverse forward direction saving threshold value ETHcO1, the MPU 60 causes the head 15 to seek to the band region BAc, reads the initial track of the band region BAc, and saves (or writes) the data of the initial track into the media cache 10b.

When determining that the number of times of reverse forward direction writing (the number of times of reverse forward direction adjacent band writing) WCcO is larger than the reverse forward direction refresh threshold value RTHcO1, the MPU 60 performs the refresh process on the band region BAc.

In the example illustrated in FIG. 12, when data is written in the forward direction of the band region BAc, for example, in the inner band region, the MPU 60 increases the number of times of forward direction writing (the number of times of forward direction adjacent band writing) WCcI corresponding to the band region BAc by one.

When determining that the number of times of forward direction writing WCcI is larger than the forward direction saving threshold value ETHcI1, the MPU 60 causes the head 15 to seek to the band region BAc, reads the last track of the band region BAc, and saves (or writes) the data of the last track into the media cache 10b.

When determining that the number of times of forward direction writing (the number of times of forward direction adjacent band writing) WCcI is larger than the forward direction refresh threshold value RTHcI1, the MPU 60 performs the refresh process on the band region BAc.

According to Modification 2, the magnetic disk device 1 has a forward direction saving threshold value and a reverse forward direction saving threshold value, and a forward direction refresh threshold value and a reverse forward direction refresh threshold value corresponding to the number of times of forward direction writing and the number of times of reverse forward direction writing, respectively. The magnetic disk device 1 can execute the refresh process with an appropriate writing count for each of the regions in the forward direction and the reverse forward direction. Therefore, the magnetic disk device 1 can improve the reliability.

(Modification 3)

The magnetic disk device 1 according to Modification 3 of the first embodiment is different from the magnetic disk device 1 according to the first embodiment, Modification 1, and Modification 2 described above in terms of the saving threshold value and the refresh threshold value.

When determining that the number of times of writing to the region in the radial direction of the target region is larger than the saving threshold value corresponding to the number of times of writing to the region in the radial direction corresponding to the target region, the refresh unit 630 performs the saving process on the data at the end portion of the target region in the reverse forward direction or the forward direction. The refresh unit 630 may hold (write) the saving threshold value as a table in a particular recording region, for example, the system area 10c of the disk 10, the volatile memory 70, the non-volatile memory 80, the buffer memory 90, or the like.

When determining that the number of times of writing to the region in the radial direction of the target region is larger than the refresh threshold value corresponding to the number of times of writing to the region in the radial direction of the target region, the refresh unit 630 performs the refresh process on the target region. The refresh unit 630 may hold the refresh threshold value as a table in a particular recording region, for example, the system area 10c of the disk 10, the volatile memory 70, the non-volatile memory 80, the buffer memory 90, or the like.

For example, when determining that the number of times of writing to the adjacent band region of the target band region is larger than the saving threshold value corresponding to this target band region, the refresh unit 630 causes the head 15 to seek to the target band region and saves the initial track and the last track of the target band region into the media cache 10b (or the system area 10c). When determining that the number of times of writing to the adjacent band region of the target band region is larger than the refresh threshold value corresponding to the target band region, the refresh unit 630 reads respective tracks of the target band region of the user data region 10a, temporarily writes data of the respective tracks of the target band region to the media cache 10b, reads the data from the media cache 10b, and performs the refresh process of rewriting the data read from the media cache 10b to the same position of the target band region. When it is determined that the number of times of writing to the adjacent band region of the target band region is larger than the refresh threshold value corresponding to the target band region and the initial track or the last track of the target band region cannot be read, the refresh unit 630 may read, from the media cache 10b, data of respective tracks other than the initial track or the last track of the target band region read from the target band region and temporarily written to the media cache 10b and data of the initial track or the last track saved into the media cache 10b by the saving process, and rewrite respective tracks of the target band region.

FIG. 13 is a schematic diagram illustrating an example of a table TB of the number of times of writing, a saving threshold value, and a refresh threshold value according to Modification 3. In FIG. 13, the table TB includes band regions BAa, BAb, and BAc, saving threshold values ETHa1, ETHb1, and ETHc1, and refresh threshold values RTHa1, RTHb1, and RTHc1. The table TB is recorded in, for example, a particular recording region, for example, the system area 10c of the disk 10, the volatile memory 70, the non-volatile memory 80, the buffer memory 90, or the like. The band regions BAa, BAb, and BAc correspond to FIG. 5. In the table TB of FIG. 13, the number of times of writing WCa corresponds to the band region BAa, the saving threshold value ETHa1 corresponds to the band region BAa, and the refresh threshold value RTHa1 corresponds to the band region BAa. In the table TB of FIG. 13, the number of times of writing WCb corresponds to the band region BAb, the saving threshold value ETHb1 corresponds to the band region BAb, and the refresh threshold value RTHb1 corresponds to the band region BAb. In the table TB of FIG. 13, the number of times of writing WCc corresponds to the band region BAc, the saving threshold value ETHc1 corresponds to the band region BAc, and the refresh threshold value RTHc1 corresponds to the band region BAc.

In the example illustrated in FIG. 13, when data is written to the band region in the radial direction of the band region BAa, the MPU 60 increases the number of times of writing WCa to the band region in the radial direction of the band region BAa by one.

When determining that the number of times of writing WCa is larger than the saving threshold value ETHa1, the MPU 60 causes the head 15 to seek to the band region BAa, reads the initial track and the last track of the band region BAa, and saves (or writes) data of the initial track and the subsequent track into the media cache 10b.

When determining that the number of times of writing WCa is larger than the refresh threshold value RTHa1, the MPU 60 performs the refresh process on the band region BAa.

In the example illustrated in FIG. 13, when data is written to the band region in the radial direction of the band region BAb, the MPU 60 increases the number of times of writing WCb to the band region in the radial direction of the band region BAb by one.

When determining that the number of times of writing WCb is larger than the saving threshold value ETHb1, the MPU 60 causes the head 15 to seek to the band region BAb, reads the initial track and the subsequent track of the band region BAb, and saves (or writes) the data of the initial track and the subsequent track into the media cache 10b.

When determining that the number of times of writing WCb is larger than the refresh threshold value RTHb1, the MPU 60 performs the refresh process on the band region BAb.

In the example illustrated in FIG. 13, when data is written to the band region in the radial direction of the band region BAc, the MPU 60 increases the number of times of writing WCc to the band region in the radial direction of the band region BAc by one.

When determining that the number of times of writing WCc is larger than the saving threshold value ETHc1, the MPU 60 causes the head 15 to seek to the band region BAc, reads the initial track and the subsequent track of the band region BAc, and saves (or writes) the data of the initial track and the subsequent track into the media cache 10b.

When determining that the number of times of writing WCc is larger than the refresh threshold value RTHc1, the MPU 60 performs the refresh process on the band region BAc.

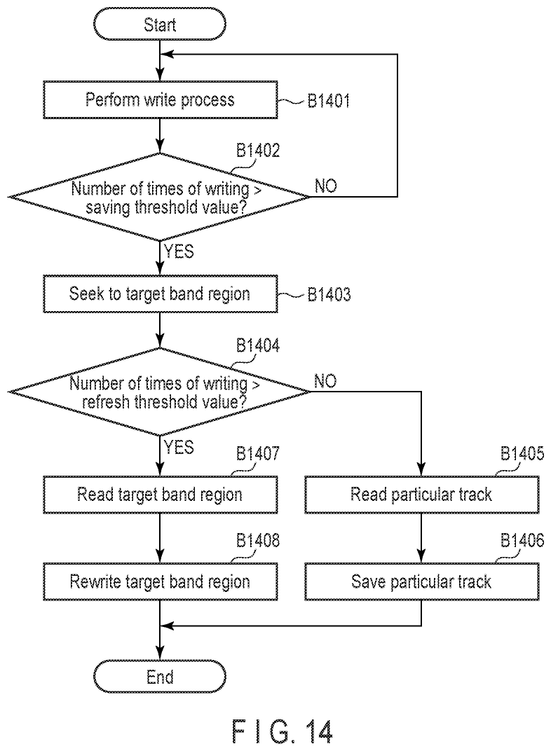

FIG. 14 is a flowchart showing an example of the refresh processing method according to Modification 3.

The MPU 60 receives a command from the host 100 and executes a write process (B1401). The MPU 60 determines whether the number of times of writing is larger than the saving threshold value corresponding to the target band region or equal to or less than the saving threshold value corresponding to the target band region (B1402). When it is determined that the number of writing is equal to or less than the saving threshold value corresponding to the target band region (NO in B1402), the MPU 60 advances the process to B1001. When it is determined that the number of times of writing is larger than the saving threshold value corresponding to the target band region (YES in B1402), the MPU 60 causes the head 15 to seek to the target band region (B1403).

The MPU 60 determines whether the number of times of writing is larger than the refresh threshold value corresponding to the target band region or equal to or less than the refresh threshold value corresponding to the target band region (B1404). When it is determined that the number of times of writing is equal to or less than the refresh threshold value corresponding to the target band region (NO in B1404), the MPU 60 reads a particular track of the target band region, for example, the initial track and the subsequent track (B1405), saves the read initial track and subsequent track into the media cache 10b (B1406), and ends the process.

When it is determined that the number of times of writing is larger than the refresh threshold value corresponding to the target band region (YES in B1404), the MPU 60 reads all tracks in the target band region (B1407), temporarily writes data of all the tracks in the target band region to the media cache 10b, reads the data from the media cache 10b, rewrites the data read from the media cache 10b to the target band region (B1408), and ends the process.

According to Modification 3, when it is determined that the number of times of writing is equal to or less than the refresh threshold value corresponding to the target band region, the magnetic disk device 1 reads a particular track of the target band region, for example, the initial track and the subsequent track, and saves the read initial track and last track into the media cache 10b. When determining that the number of times of writing is larger than the refresh threshold value corresponding to the target band region, the magnetic disk device 1 reads all tracks of the target band region, temporarily writes data of all the tracks of the target band region to the media cache 10b, reads the data from the media cache 10b, and rewrites the data read from the media cache 10b to the target band region. Therefore, the magnetic disk device 1 can improve the performance.

### Second Embodiment

The magnetic disk device 1 according to the second embodiment is different from the magnetic disk device 1 according to the first embodiment, Modification 1, Modification 2, and Modification 3 described above in that a plurality of saving threshold values is provided for each particular region.

A refresh unit 630 has a saving threshold value (hereinafter, may be referred to as a first saving threshold value) in which the number of times of writing corresponding to the target region is the smallest among the plurality of saving threshold values corresponding to the target region, and a saving threshold value (hereinafter, may be referred to as a second saving threshold value) in which the number of times of writing corresponding to the target region is the second smallest among the plurality of saving threshold values corresponding to the target region. Note that refresh unit 630 may have three or more different saving threshold values corresponding to the target region. The second saving threshold value is larger than the first saving threshold value. The plurality of saving threshold values is smaller than the refresh threshold value. That is, the second saving threshold value is smaller than the refresh threshold value. For example, the first saving threshold value corresponds to the number of times of writing to the region in the radial direction of the target region in which the data at the end portion of the target region receives ATI larger than the amount that destroys the data. For example, the second saving threshold value corresponds to the number of times of writing to the region in the radial direction of the target region in which the data of the region adjacent to the end portion of the target region in the radial direction receives ATI larger than the amount that destroys the data. When determining that the number of times of writing is larger than the first saving threshold value corresponding to the target region, the refresh unit 630 performs the saving process on the data at the end portion of the target region. When determining that the number of times of writing is larger than the second saving threshold value corresponding to the target region, the refresh unit 630 performs the saving process on the data of the region adjacent to the end portion of the target region in the radial direction. The refresh unit 630 may perform the saving process on the data of each region away from the end portion of the target region in the radial direction every time the number of times of writing corresponding to the target region exceeds each saving threshold value corresponding to the target region. The refresh unit 630 may hold a plurality of saving threshold values as a table in a particular recording region, for example, the system area 10c of the disk 10, the volatile memory 70, the non-volatile memory 80, the buffer memory 90, or the like.

For example, when determining that the number of times of writing corresponding to the target band region is larger than the first saving threshold value corresponding to this target band region, the refresh unit 630 causes the head 15 to seek to the target band region and saves the initial track of the target band region into the media cache 10b (or the system area 10c). When determining that the number of times of writing corresponding to the target band region is larger than the second saving threshold value corresponding to this target band region, the refresh unit 630 causes the head 15 to seek to the target band region, and saves the adjacent track (hereinafter, may be referred to as an initial adjacent track), next to the initial track, with which the initial track in the target band region is overwritten into the media cache 10b (or the system area 10c).

When determining that the number of times of writing corresponding to the target band region is larger than the refresh threshold value corresponding to the target band region, the refresh unit 630 reads respective tracks of the target band region of the user data region 10a, temporarily writes data of the respective tracks of the target band region to the media cache 10b, reads the data from the media cache 10b, and performs the refresh process of rewriting the data from the media cache 10b to the same position of the target band region. When it is determined that the number of times of writing corresponding to the target band region is larger than the refresh threshold value corresponding to the target band region and the initial track and the initial adjacent track of the target band region cannot be read, the refresh unit 630 may read, from the media cache 10b, data of respective tracks other than the initial track and the initial adjacent track of the target band region read from the target band region and temporarily written to the media cache 10b and data of the initial track and the initial adjacent track saved into the media cache 10b by the saving process, and rewrite respective tracks of the target band region.

In addition, when determining that the number of times of writing corresponding to the target band region is larger than the refresh threshold value corresponding to this target band region, the refresh unit 630 reads respective tracks other than the initial track and the initial adjacent track from the target band region, and temporarily writes the respective tracks other than the initial track and the initial adjacent track of the target band region to the media cache 10b. The refresh unit 630 may read, from the media cache 10b, the data of respective tracks other than the initial track and the initial adjacent track of the target band region and the data of the initial track and the initial adjacent track saved in the media cache 10b by the saving process and rewrite respective tracks of the target band region.

For example, when determining that the number of times of forward direction writing corresponding to the target band region is larger than the first saving threshold value corresponding to this target band region, the refresh unit 630 causes the head 15 to seek to the target band region and saves the last track of the target band region into the media cache 10b (or the system area 10c). When determining that the number of times of forward direction writing corresponding to the target band region is larger than the second saving threshold value corresponding to this target band region, the refresh unit 630 causes the head 15 to seek to the target band region, and saves an adjacent track, immediately before the last track, that is overwritten with the last track of the target band region, that is, a track, adjacent to the last track, that is written immediately before the last track (hereinafter, may be referred to as a last adjacent track) into the media cache 10b (or the system area 10c).

When determining that the number of times of forward direction writing corresponding to the target band region is larger than the refresh threshold value corresponding to this target band region, the refresh unit 630 reads respective tracks of the target band region of the user data region 10a, temporarily writes data of the respective tracks of the target band region to the media cache 10b, reads the data from the media cache 10b, and performs the refresh process of rewriting the data read from the media cache 10b to the same position of the target band region. When it is determined that the number of times of forward direction writing corresponding to the target band region is larger than the refresh threshold value corresponding to the target band region and the last track and the last adjacent track of the target band region cannot be read, the refresh unit 630 may read, from the media cache 10b, data of respective tracks other than the last track and the last adjacent track of the target band region read from the target band region and temporarily written to the media cache 10b and data of the last track and the last adjacent track saved into the media cache 10b by the saving process, and rewrite respective tracks of the target band region.

In addition, when determining that the number of times of forward direction writing corresponding to the target band region is larger than the refresh threshold value corresponding to this target band region, the refresh unit 630 reads respective tracks other than the last track and the last adjacent track from the target band region, and temporarily writes the respective tracks other than the last track and the last adjacent track of the target band region to the media cache 10b. The refresh unit 630 may read, from the media cache 10b, the data of respective tracks other than the last track and the last adjacent track of the target band region and the data of the last track and the last adjacent track saved in the media cache 10b by the saving process and rewrite respective tracks of the target band region.

For example, when determining that the number of times of reverse forward direction writing corresponding to the target band region is larger than the first saving threshold value corresponding to this target band region, the refresh unit 630 causes the head 15 to seek to the target band region and saves the initial track of the target band region into the media cache 10b (or the system area 10c). When determining that the number of times of reverse forward direction writing corresponding to the target band region is larger than the second saving threshold value corresponding to this band region, the refresh unit 630 causes the head 15 to seek to the target band region and saves the initial adjacent track of the target band region into the media cache 10b (or the system area 10c).

When determining that the number of times of reverse forward direction writing corresponding to the target band region is larger than the refresh threshold value corresponding to the target band region, the refresh unit 630 reads respective tracks of the target band region of the user data region 10a, temporarily writes data of the respective tracks of the target band region to the media cache 10b, reads the data from the media cache 10b, and performs the refresh process of rewriting the data read from the media cache 10b to the same position of the target band region. When it is determined that the number of times of reverse forward direction writing corresponding to the target band region is larger than the refresh threshold value corresponding to the target band region and the initial track and the initial adjacent track of the target band region cannot be read, the refresh unit 630 may read, from the media cache 10b, data of respective tracks other than the initial track and the initial adjacent track of the target band region read from the target band region and temporarily written to the media cache 10b and data of the initial track and the initial adjacent track saved into the media cache 10b by the saving process, and rewrite respective tracks of the target band region.

In addition, when determining that the number of times of reverse forward direction writing corresponding to the target band region is larger than the refresh threshold value corresponding to this target band region, the refresh unit 630 reads respective tracks other than the initial track and the initial adjacent track from the target band region, and temporarily writes the respective tracks other than the initial track and the initial adjacent track of the target band region to the media cache 10b. The refresh unit 630 may read, from the media cache 10b, the data of respective tracks other than the initial track and the initial adjacent track of the target band region and the data of the initial track and the initial adjacent track saved in the media cache 10b by the saving process and rewrite respective tracks of the target band region.

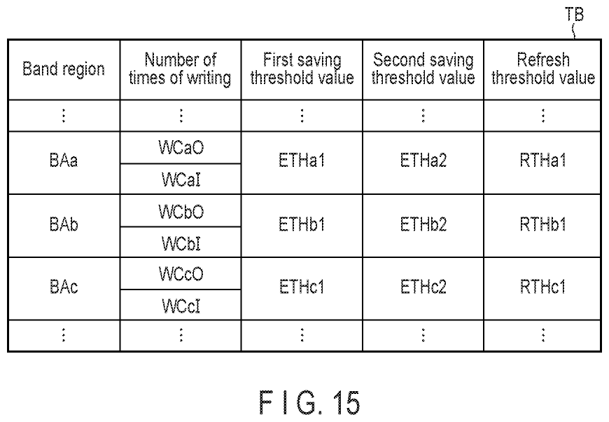

FIG. 15 is a schematic diagram illustrating an example of a table TB of the number of times of writing, a saving threshold value, and a refresh threshold value according to the second embodiment. In FIG. 15, the table TB includes band regions BAa, BAb, and BAc, the number of times of writings WaO, WCaI, WCbO, WCbI, WCcO, and WCcI, first saving threshold values ETHa1, ETHb1, and ETHc1, second saving threshold values ETHa2, ETHb2, and ETHc2, and refresh threshold values RTHa1, RTHb1, and RTHc1. The table TB is recorded in, for example, a particular recording region, for example, the system area 10c of the disk 10, the volatile memory 70, the non-volatile memory 80, the buffer memory 90, or the like. The band regions BAa, BAb, and BAc correspond to FIG. 5. In the table TB of FIG. 15, the first saving threshold value ETHa1 and the second saving threshold value ETHa2 correspond to the band region BAa. In the table TB of FIG. 15, the first saving threshold value ETHb1 and the second saving threshold value ETHb2 correspond to the band region BAb. In the table TB of FIG. 15, the first saving threshold value ETHc1 and the second saving threshold value ETHc2 correspond to the band region BAc.

In the example illustrated in FIG. 15, when data is written in the reverse forward direction of the band region BAa, for example, in the outer band region, the MPU 60 increases the number of times of reverse forward direction writing (the number of times of reverse forward direction adjacent band writing) WCaO corresponding to the band region BAa by one.

When determining that the number of times of reverse forward direction writing (the number of times of reverse forward direction adjacent band writing) WCaO is larger than the first saving threshold value ETHa1, the MPU 60 causes the head 15 to seek to the band region BAa, reads the initial track of the band region BAa, and saves (or writes) data of the initial track into the media cache 10b.

When determining that the number of times of reverse forward direction writing (the number of times of reverse forward direction adjacent band writing) WCaO is larger than the second saving threshold value ETHa2, the MPU 60 causes the head 15 to seek to the band region BAa, reads the initial adjacent track of the band region BAa, and saves (or writes) the data of the initial adjacent track into the media cache 10b.

When determining that the number of times of reverse forward direction writing (the number of times of reverse forward direction adjacent band writing) WCaO is larger than the refresh threshold value RTHa1, the MPU 60 performs the refresh process on the band region BAa.

In the example illustrated in FIG. 15, when data is written in the forward direction of the band region BAa, for example, the inner band region BAb, the MPU 60 increases the number of times of forward direction writing (the number of times of forward direction adjacent band writing) WCaI corresponding to the band region BAa by one.

When determining that the number of times of forward direction writing (the number of times of forward direction adjacent band writing) WCaI is larger than the first saving threshold value ETHa1, the MPU 60 causes the head 15 to seek to the band region BAa, reads the last track of the band region BAa, and saves (or writes) the data of the last track into the media cache 10b.

When determining that the number of times of forward direction writing (the number of times of forward direction adjacent band writing) WCaI is larger than the second saving threshold value ETHa2, the MPU 60 causes the head 15 to seek to the band region BAa, reads the last adjacent track of the band region BAa, and saves (or writes) the data of the last adjacent track into the media cache 10b.

When determining that the number of times of forward direction writing (the number of times of forward direction adjacent band writing) WCaI is larger than the refresh threshold value RTHa1, the MPU 60 performs the refresh process on the band region BAa.

In the example illustrated in FIG. 15, when data is written in the reverse forward direction of the band region BAb, for example, in the outer band region BAa, the MPU 60 increases the number of times of reverse forward direction writing (the number of times of reverse forward direction adjacent band writing) WCbO corresponding to the band region BAb by one.

When determining that the number of times of reverse forward direction writing (the number of times of reverse forward direction adjacent band writing) WCbO is larger than the first saving threshold value ETHb1, the MPU 60 causes the head 15 to seek to the band region BAb, reads the initial track of the band region BAb, and saves (or writes) the data of the initial track into the media cache 10b.

When determining that the number of times of reverse forward direction writing (the number of times of reverse forward direction adjacent band writing) WCbO is larger than the second saving threshold value ETHb2, the MPU 60 causes the head 15 to seek to the band region BAb, reads the initial adjacent track of the band region BAb, and saves (or writes) the data of the initial adjacent track into the media cache 10b.

When determining that the number of times of reverse forward direction writing (the number of times of reverse forward direction adjacent band writing) WCbO is larger than the refresh threshold value RTHb1, the MPU 60 performs the refresh process on the band region BAb.

In the example illustrated in FIG. 15, when data is written in the forward direction of the band region BAb, for example, the inner band region BAc, the MPU 60 increases the number of times of forward direction writing (the number of times of forward direction adjacent band writing) WCbI corresponding to the band region BAb by one.

When determining that the number of times of forward direction writing (the number of times of forward direction adjacent band writing) WCbI is larger than the first saving threshold value ETHb1, the MPU 60 causes the head 15 to seek to the band region BAb, reads the last track of the band region BAb, and saves (or writes) the data of the last track into the media cache 10b.

When determining that the number of times of forward direction writing (the number of times of forward direction adjacent band writing) WCbI is larger than the second saving threshold value ETHb2, the MPU 60 causes the head 15 to seek to the band region BAb, reads the last adjacent track of the band region BAb, and saves (or writes) the data of the last adjacent track into the media cache 10b.

When determining that the number of times of forward direction writing (the number of times of forward direction adjacent band writing) WCbI is larger than the refresh threshold value RTHb1, the MPU 60 performs the refresh process on the band region BAb.

In the example illustrated in FIG. 15, when data is written in the reverse forward direction of the band region BAc, for example, in the outer band region BAb, the MPU 60 increases the number of times of reverse forward direction writing (the number of times of reverse forward direction adjacent band writing) WCcO corresponding to the band region BAc by one.

When determining that the number of times of reverse forward direction writing (the number of times of reverse forward direction adjacent band writing) WCcO is larger than the first saving threshold value ETHc1, the MPU 60 causes the head 15 to seek to the band region BAc, reads the initial track of the band region BAc, and saves (or writes) data of the initial track into the media cache 10b.

When determining that the number of times of reverse forward direction writing (the number of times of reverse forward direction adjacent band writing) WCcO is larger than the second saving threshold value ETHc2, the MPU 60 causes the head 15 to seek to the band region BAc, reads the initial adjacent track of the band region BAc, and saves (or writes) the data of the initial adjacent track into the media cache 10b.

When determining that the number of times of reverse forward direction writing (the number of times of reverse forward direction adjacent band writing) WCcO is larger than the refresh threshold value RTHc1, the MPU 60 performs the refresh process on the band region BAc.

In the example illustrated in FIG. 15, when data is written in the forward direction of the band region BAc, for example, in the inner band region, the MPU 60 increases the number of times of forward direction writing (the number of times of forward direction adjacent band writing) WCcI corresponding to the band region BAc by one.

When determining that the number of times of forward direction writing (the number of times of forward direction adjacent band writing) WCcI is larger than the first saving threshold value ETHc1, the MPU 60 causes the head 15 to seek to the band region BAc, reads the last track of the band region BAc, and saves (or writes) the data of the last track into the media cache 10b.

When determining that the number of times of forward direction writing (the number of times of forward direction adjacent band writing) WCcI is larger than the second saving threshold value ETHc2, the MPU 60 causes the head 15 to seek to the band region BAc, reads the last adjacent track of the band region BAc, and saves (or writes) the data of the last adjacent track into the media cache 10b.

When determining that the number of times of forward direction writing (the number of times of forward direction adjacent band writing) WCcI is larger than the refresh threshold value RTHc1, the MPU 60 performs the refresh process on the band region BAc.

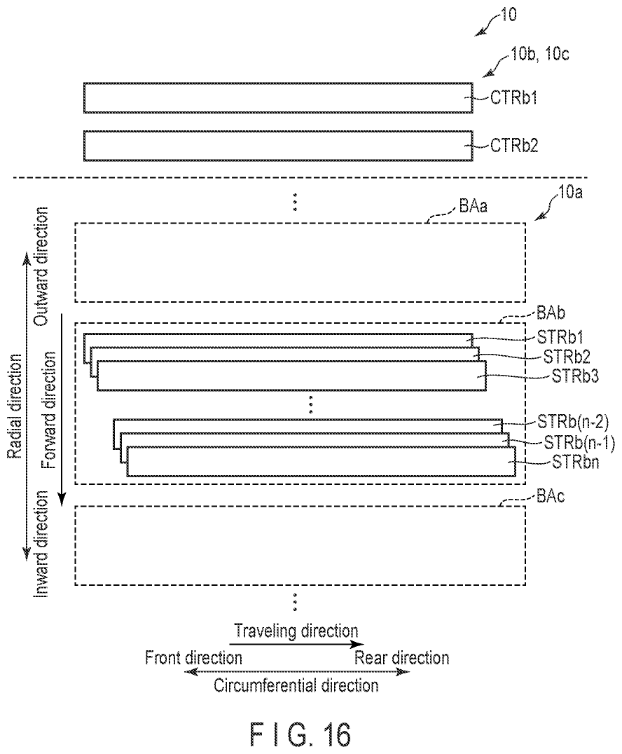

FIG. 16 is a schematic diagram illustrating an example of a saving processing method and a refresh processing method according to the second embodiment. FIG. 16 corresponds to FIG. 5. FIG. 16 illustrates the initial track CTRb1 and the initial adjacent track CTRb2. The track CTRb1 corresponds to the track STRb1. The data of the track CTRb1 corresponds to the data of the track STRb1. The track CTRb2 corresponds to the track STRb2. The data of the track CTRb2 corresponds to the data of the track STRb2.

In the example illustrated in FIG. 16, when data is written to the band region BAa, the MPU 60 increases the number of times of reverse forward direction writing corresponding to the band region BAb by one. When determining that the number of times of reverse forward direction writing corresponding to the band region BAb is larger than the first saving threshold value corresponding to the band region BAb, the MPU 60 causes the head 15 to seek to the band region BAb, reads the initial track STRb1 of the band region BAb, and saves (or writes) the data of the initial track STRb1 into the media cache 10b (or the system area 10c) as the track CTRb1.

When determining that the number of times of reverse forward direction writing corresponding to the band region BAb is larger than the second saving threshold value corresponding to the band region BAb, the MPU 60 causes the head 15 to seek to the band region BAb, reads the initial adjacent track STRb2 of the band region BAb, and saves (or writes) the data of the initial adjacent track STRb2 into the media cache 10b (or the system area 10c) as the track CTRb2.

When determining that the number of times of reverse forward direction writing corresponding to the band region BAb is larger than the refresh threshold value corresponding to the band region BAb, the MPU 60 reads the tracks STRb1 to STRbn from the band region BAb, temporarily writes the data of the tracks STRb1 to STRbn to the media cache 10b, reads the data from the media cache 10b, and rewrites the data read from the media cache 10b to the band region BAb. Note that, when it is determined that the number of times of reverse forward direction writing corresponding to the band region BAb is larger than the refresh threshold value corresponding to the band region BAb, and the tracks STRb1 and STRb2 cannot be read, the MPU 60 may read the data of the track CTRb1, the track CTRb2, and the tracks STRb2 to STRbn from the media cache 10b, and rewrite the data of the tracks STRb1 to STRbn to the band region BAb.

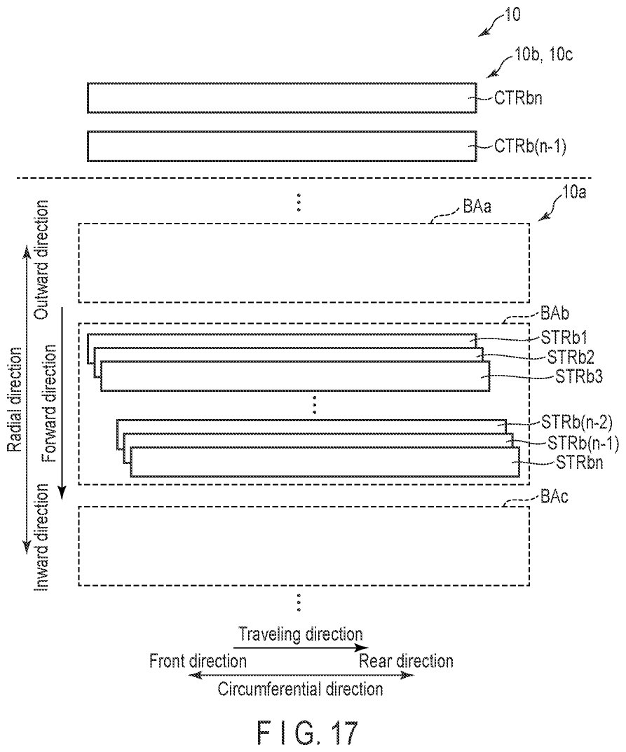

FIG. 17 is a schematic diagram illustrating an example of a saving processing method and a refresh processing method according to the second embodiment. FIG. 17 corresponds to FIG. 5. FIG. 17 illustrates the last track CTRbn and the last adjacent track CTRb(n−1). The track CTRbn corresponds to the track STRbn. The data of the track CTRb corresponds to the data of the track STRbn. The track CTRb(n−1) corresponds to the track STRb(n−1). The data of the track CTRb(n−1) corresponds to the data of the track STRb(n−1).

In the example illustrated in FIG. 17, when data is written to the band region BAc, the MPU 60 increases the number of times of forward direction writing corresponding to the band region BAb by one. When determining that the number of times of forward direction writing corresponding to the band region BAb is larger than the first saving threshold value corresponding to the band region BAb, the MPU 60 causes the head 15 to seek to the band region BAb, reads the last track STRbn of the band region BAb, and saves (or writes) the data of the last track STRbn as the track CTRbn into the media cache 10b (or the system area 10c).

When determining that the number of times of forward direction writing corresponding to the band region BAb is larger than the second saving threshold value corresponding to the band region BAb, the MPU 60 causes the head 15 to seek to the band region BAb, reads the last adjacent track STRb(n−1) of the band region BAb, and saves (or writes) the data of the last adjacent track STRb(n−1) into the media cache 10b (or the system area 10c) as the track CTRb(n−1).

When determining that the number of times of forward direction writing corresponding to the band region BAb is larger than the refresh threshold value corresponding to the band region BAb, the MPU 60 reads the tracks STRb1 to STRbn from the band region BAb, temporarily writes the data of the tracks STRb1 to STRbn to the media cache 10b, reads the data from the media cache 10b, and rewrites the data read from the media cache 10b to the band region BAb. When it is determined that the number of times of forward direction writing corresponding to the band region BAb is larger than the refresh threshold value and the last track STRbn and the last adjacent track STRb(n−1) cannot be read, the MPU 60 may read the data of the track CTRbn, the track CTRb(n−1), and the tracks STRb1 to STRb(n−2) from the media cache 10b, and rewrite the data of the tracks STRb1 to STRbn to the band region BAb.

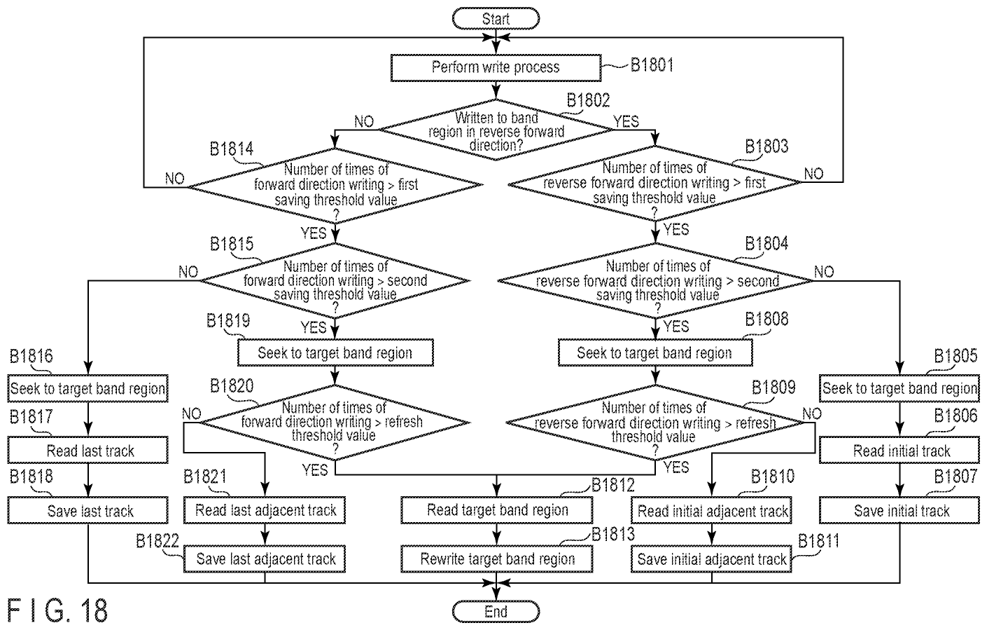

FIG. 18 is a flowchart showing an example of a refresh processing method according to the second embodiment.

The MPU 60 receives a command from the host 100 and executes a write process (B1801). The MPU 60 determines whether data is written to the band region in the reverse forward direction of the target band region (B1802). In other words, the MPU 60 determines whether data is written to the band region in the reverse forward direction of the target band region or data is written to the band region in the forward direction of the target band region.

When determining that the data is written to the band region in the reverse forward direction of the target band region (YES in B1802), the MPU 60 determines whether the number of times of reverse forward direction writing is larger than the first saving threshold value corresponding to the target band region or equal to or less than the first saving threshold value corresponding to the target band region (B1803). When it is determined that the number of times of reverse forward direction writing is equal to or less than the first saving threshold value corresponding to the target band region (NO in B1803), the MPU 60 advances the process to B1801. When it is determined that the number of times of reverse forward direction writing is larger than the first saving threshold value corresponding to the target band region (YES in B1803), the MPU 60 determines whether the number of times of reverse forward direction writing is larger than the second saving threshold value corresponding to the target band region or equal to or less than the second saving threshold value corresponding to the target band region (B1804).

When it is determined that the number of times of reverse forward direction writing is equal to or less than the second saving threshold value corresponding to the target band region (NO in B1804), the MPU 60 causes the head 15 to seek to the target band region (B1805). The MPU 60 reads the initial track of the target band region (B1806), saves the read initial track into the media cache 10b (B1807), and ends the process.

When it is determined that the number of times of reverse forward direction writing is equal to or less than the second saving threshold value corresponding to the target band region (YES in B1804), the MPU 60 causes the head 15 to seek to the target band region (B1808). The MPU 60 determines whether the number of times of reverse forward direction writing is larger than the refresh threshold value corresponding to the target band region or equal to or less than the refresh threshold value corresponding to the target band region (B1809). When it is determined that the number of times of reverse forward direction writing is equal to or less than the refresh threshold value corresponding to the target band region (NO in B1809), the MPU 60 reads the initial adjacent track of the target band region (B1810), saves the read initial adjacent track into the media cache 10b (B1811), and ends the process.

When it is determined that the number of times of reverse forward direction writing is larger than the refresh threshold value corresponding to the target band region (YES in B1809), the MPU 60 reads all tracks in the target band region (B1812), temporarily writes data of all the tracks in the target band region to the media cache 10b, reads the data from the media cache 10b, rewrites the data read from the media cache 10b to the target band region (B1813), and ends the process.

When it is determined that the data is not written to the band region in the reverse forward direction of the target band region, that is, the data is written to the band region in the forward direction of the target band region (NO in B1802), the MPU 60 determines whether the number of times of forward direction writing is larger than the first saving threshold value corresponding to the target band region or equal to or less than the first saving threshold value corresponding to the target band region (B1814). When it is determined that the number of times of forward direction writing is equal to or less than the first saving threshold value corresponding to the target band region (NO in B1814), the MPU 60 advances the process to B1801. When determining that the number of times of forward direction writing is larger than the first saving threshold value corresponding to the target band region (YES in B1814), the MPU 60 determines whether the number of times of forward direction writing is larger than the second saving threshold value corresponding to the target band region or equal to or less than the second saving threshold value corresponding to the target band region (B1815).

When it is determined that the number of times of forward direction writing is equal to or less than the second saving threshold value corresponding to the target band region (NO in B1815), the MPU 60 causes the head 15 to seek to the target band region (B1816). The MPU 60 reads the last track of the target band region (B1817), saves the read last track into the media cache 10b (B1818), and ends the process.

When it is determined that the number of times of forward direction writing is equal to or less than the second saving threshold value corresponding to the target band region (YES in B1815), the MPU 60 causes the head 15 to seek to the target band region (B1819). The MPU 60 determines whether the number of times of forward direction writing is larger than the refresh threshold value corresponding to the target band region or equal to or less than the refresh threshold value corresponding to the target band region (B1820). When determining that the number of times of forward direction writing is equal to or less than the refresh threshold value corresponding to the target band region (NO in B1820), the MPU 60 reads the last adjacent track of the target band region (B1821), saves the read last adjacent track into the media cache 10b (B1822), and ends the process.

When determining that the number of times of forward direction writing is larger than the refresh threshold value corresponding to the target band region (YES in B1820), the MPU 60 advances the process to B1812.

According to the embodiment, the magnetic disk device 1 has a plurality of saving threshold values and refresh threshold values for each band region. When determining that the number of times of reverse forward direction writing is larger than the first saving threshold value corresponding to the target band region, the magnetic disk device 1 determines whether the number of times of reverse forward direction writing is larger than the second saving threshold value corresponding to the target band region or equal to or less than the second saving threshold value corresponding to the target band region. When determining that the number of times of reverse forward direction writing is equal to or less than the second saving threshold value corresponding to the target band region, the magnetic disk device 1 causes the head 15 to seek to the target band region, reads the initial track of the target band region, and saves the read initial track into the media cache 10b. When determining that the number of times of reverse forward direction writing is equal to or less than the refresh threshold value corresponding to the target band region, the magnetic disk device 1 causes the head 15 to seek to the target band region, reads the initial adjacent track of the target band region, and saves the read initial adjacent track into the media cache 10b. When determining that the number of times of reverse forward direction writing is equal to or less than the refresh threshold value corresponding to the target band region, the magnetic disk device 1 reads all tracks in the target band region, temporarily writes data of all the tracks in the target band region to the media cache 10b, reads the data from the media cache 10b, and rewrites the data read from the media cache 10b to the target band region.

When determining that the number of times of forward direction writing is larger than the first saving threshold value corresponding to the target band region, the magnetic disk device 1 determines whether the number of times of forward direction writing is larger than the second saving threshold value corresponding to the target band region or equal to or less than the second saving threshold value corresponding to the target band region. When determining that the number of times of forward direction writing is equal to or less than the second saving threshold value corresponding to the target band region, the magnetic disk device 1 causes the head 15 to seek to the target band region, reads the last track of the target band region, and saves the read last track into the media cache 10b. When determining that the number of times of forward direction writing is equal to or less than the refresh threshold value corresponding to the target band region, the magnetic disk device 1 causes the head 15 to seek to the target band region, reads the last adjacent track of the target band region, and saves the read last adjacent track into the media cache 10b. When determining that the number of times of forward direction writing is equal to or less than the refresh threshold value corresponding to the target band region, the magnetic disk device 1 reads all tracks in the target band region, temporarily writes data of all the tracks in the target band region to the media cache 10b, reads the data from the media cache 10b, and rewrites the data read from the media cache 10b to the target band region. Therefore, the magnetic disk device 1 can reduce the frequency of the refresh process. Therefore, the magnetic disk device 1 can improve performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a disk including a user data region having a first region to which data is written by shingled recording in which a plurality of tracks is written in an overlapping manner in a first direction of a radial direction and a cache region to which data is written by normal recording in which a plurality of tracks is written at intervals in a radial direction and is temporarily written before writing the data in the user data region;
a head that writes data to the disk and reads data from the disk; and
a controller including a first saving threshold value of the number of times of writing that data is written in the radial direction of the first region for saving a track located at an end portion of the first region in the radial direction into the cache region, and a refresh threshold value of the number of times of the writing for rewriting a plurality of tracks shingled recorded in the first region.

2. The magnetic disk device according to claim 1, wherein the refresh threshold value is larger than the first saving threshold value.

3. The magnetic disk device according to claim 2, wherein when the number of times of first writing that data is written in a second direction opposite to the first direction in the first region is larger than the first saving threshold value, the controller writes a first track located at an end portion of the first region in the second direction to the cache region.

4. The magnetic disk device according to claim 3, wherein when the number of times of second writing that data is written in the first direction of the first region is larger than the first saving threshold value, the controller writes a second track located at an end portion of the first region in the first direction to the cache region.

5. The magnetic disk device according to claim 4, wherein when the number of times of the first writing or the number of times of the second writing is larger than the refresh threshold value, the controller reads all tracks shingled recorded in the first region and temporarily writes the tracks to the cache region, and rewrites all the tracks read from the cache region to the first region.

6. The magnetic disk device according to claim 4, wherein when the number of times of the first writing or the number of times of the second writing is larger than the refresh threshold value, the controller reads a first track group other than the first track or the second track among all tracks shingled recorded in the first region and temporarily writes the first track group to the cache region, and rewrites the first track or the second track, and the first track group read from the cache region to the first region.

7. The magnetic disk device according to claim 4, wherein
the controller has a second saving threshold value of the number of times of the writing for the first region for saving a track located at a most end portion of the first region in the radial direction into the cache region, and
the second saving threshold value is larger than the first saving threshold value and smaller than the refresh threshold value.

8. The magnetic disk device according to claim 7, wherein when the number of times of the first writing is larger than the second saving threshold value, the controller writes, to the cache region, a third track with which a first track located at an end portion of the first region in the second direction is overwritten.

9. The magnetic disk device according to claim 8, wherein when the number of times of the second writing is larger than the second saving threshold value, the controller writes, to the cache region, a fourth track written immediately before a second track located at an end portion of the first region in the first direction.

10. The magnetic disk device according to claim 9, wherein when the number of times of the first writing or the number of times of the second writing is larger than the refresh threshold value, the controller reads a second track group other than the first track and the third track, or the second track and the fourth track among all tracks shingled recorded in the first region, temporarily writes the second track group to the cache region, and rewrites, to the first region, the first track and the third track, or the second track and the fourth track, and the second track group read from the cache region.

11. A magnetic disk device comprising:
a disk including a user data region having a first region to which data is written by shingled recording in which a plurality of tracks is written in an overlapping manner in a first direction in a radial direction and a cache region in which data is written by normal recording in which a plurality of tracks is written at intervals in a radial direction and is temporarily written before writing the data in the user data region;
a head that writes data to the disk and reads data from the disk; and
a controller that reads a first track located at an end portion of the first region in a radial direction from the first region and writes the first track to the cache region when the number of times of writing that data is written in the radial direction of the first region is larger than a first saving threshold value, and reads at least a first track group other than the first track among all tracks shingled recorded in the first region from the first region, temporarily writes the first track group to the cache region, and rewrites the first track and the first track group read from the cache region to the first region when the number of the writing is larger than a refresh threshold value larger than the first saving threshold value.

12. The magnetic disk device according to claim 11, wherein when the number of times of writing that data is written in the radial direction of the first region is larger than a first saving threshold value, the controller reads, from the first region, a first track located at an end portion of the first region in a second direction opposite to the first direction and writes the first track to the cache region.

13. The magnetic disk device according to claim 11, wherein when the number of times of writing that data is written in the radial direction of the first region is larger than a first saving threshold value, the controller reads, from the first region, a first track located at an end portion of the first region in the first direction and writes the first track to the cache region.

14. A refresh processing method applied to a magnetic disk device including a disk including a user data region having a first region to which data is written by shingled recording in which a plurality of tracks is written in an overlapping manner in a first direction in a radial direction and a cache region to which data is written by normal recording in which a plurality of tracks is written at intervals in the radial direction and is temporarily written before writing the data in the user data region, and a head that writes data to the disk and reads data from the disk,
the magnetic disk device including a first saving threshold value of the number of times of writing that data is written in the radial direction of the first region for saving a track located at an end portion of the first region in the radial direction into the cache region and a refresh threshold value of the number of times of the writing for rewriting a plurality of tracks shingled recorded in the first region,
the refresh threshold value being larger than the first saving threshold value,
the method comprising:
when the number of times of first writing that data is written in a second direction opposite to the first direction in the first region is larger than the first saving threshold value, writing a first track located at an end portion of the first region in the second direction to the cache region.

15. The refresh processing method according to claim 14, further comprising when the number of times of second writing that data is written in the first direction in the first region is larger than the first saving threshold value, writing a second track located at an end portion of the first region in the first direction to the cache region.

16. The refresh processing method according to claim 15, further comprising:
when the number of times of the first writing or the number of times of the second writing is larger than the refresh threshold value, reading all tracks shingled recorded in the first region and temporarily writing the tracks in the cache region, and
rewriting all the tracks read from the cache region to the first region.

17. The refresh processing method according to claim 15, further comprising:
when the number of times of the first writing or the number of times of the second writing is larger than the refresh threshold value, reading a first track group other than the first track or the second track among all tracks shingled recorded in the first region and temporarily writing the first track group to the cache region, and
rewriting the first track or the second track, and the first track group read from the cache region to the first region.

18. The refresh processing method according to claim 15, wherein
the magnetic disk device includes a second saving threshold value of the number of times of the writing for the first region for saving a track located at a most end portion of the first region in the radial direction into the cache region, and
the second saving threshold value is larger than the first saving threshold value and smaller than the refresh threshold value.

19. The refresh processing method according to claim 18, further comprising when the number of times of the first writing is larger than the second saving threshold value, writing, to the cache region, a third track with which a first track located at an end portion of the first region in the second direction is overwritten.

20. The refresh processing method according to claim 19, further comprising when the number of times of the second writing is larger than the second saving threshold value, writing a fourth track written immediately before a second track located at an end portion of the first region in the first direction to the cache region.
